(19) United States
(12) Patent Application Publication
(10) Pub. No.: US 2004/0039663 A1
(43) Pub. Date: Feb. 26, 2004

(54) Integrated market exchange system, apparatus and method facilitating trade in graded encapsulated objects

(76) Inventor: James J. Kernz, Perrysburg, OH (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/649,039

(22) Filed: Aug. 27, 2003

Related U.S. Application Data
(63) Continuation-in-part of application No. 10/055,603, filed on Jan. 23, 2002, now Pat. No. 6,640,232.
Application No. 10/055,603 is a division of application No. 09/259,189, filed on Feb. 26, 1999, now Pat. No. 6,366,899.
(60) Provisional application No. 60/469,639, filed on May 12, 2003.

(51) Int. Cl. G06F 17/60

(52) U.S. Cl. 705/27

(57) ABSTRACT

A method and a system facilitating trade in graded encapsulated commoditized objects such as coins includes a marketplace computer operatively controlled by an online peer-to-peer trade enabling facility and storing data associated with offers to sell and offers to buy the objects being selected from a plurality of graded encapsulated objects provided by at least one third party grading firm. A host computer operatively controlled by a market maker engaged in the trade of the graded encapsulated commoditized objects stores relevant trade data associated with the objects. The Internet can be used to connect the computers and to connect sellers and buyers with the marketplace computer whereby the sellers and the buyers are provided access to the relevant trade data stored in the host computer.

### CROSS-REFERENCE TO RELATED APPLICATIONS

This application is a continuation-in-part of co-pending U.S. patent application Ser. No. 10/055,603, filed Jan. 23, 2002, which is a divisional of U.S. patent application Ser. No. 09/259,189, filed Feb. 26, 1999, now U.S. Pat. No. 6,366,899 issued Apr. 2, 2002.

This application claims the benefit of U.S. provisional patent application Serial No. 60/469,639, filed May 12, 2003.

### COPYRIGHT AND TRADEMARK NOTICE

A portion of the disclosure of this patent document contains material, which is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be registered trademarks of third parties affiliated or unaffiliated with the applicant or the assignee. Use of these marks is for the purpose of providing an enabling disclosure by way of example and shall not be construed to limit the scope of this invention to material strictly associated with such marks. By referring to such marks, neither the applicant nor the assignee intends to claim ownership or association with such marks.

### OVERVIEW

The present invention relates to the exchange of commoditized encapsulated graded objects. The present invention provides an improved market exchange environment in which buyers and sellers using interconnected computers may engage in the exchange of graded encapsulated objects wherein the objects to be traded are uniquely commoditized according to the teachings disclosed herein. The present invention will be described in the context of a virtual active marketplace operating within a computer network environment such as the World Wide Web component of the Internet. While the preferred embodiment of the present invention will be discussed in the context of numismatic material, it will be understood by those skilled in the art that the present invention can also be used to improve the fair exchange of a variety of graded encapsulated objects including collectible stamps, sports trading cards, currency, documents and the like.

Embodiments of the present invention include features and components that individually and collectively provide new, novel and non-obvious marketplace activities leading to an overall improvement in trading effectiveness.

### BACKGROUND OF THE INVENTION

The present invention relates generally to an apparatus and method for exchanging numismatic material. More specifically, the present invention relates to an apparatus and method for creating a virtual exchange in which buyers and sellers can offer and examine collectable coins including items considered to be exonumia such as tokens, medals and the like.

The art of numismatics, more commonly known as coin collecting, is one of the world's oldest hobbies. People have exchanged collectible coins for almost as long as man has used them as a medium of exchange. In the late nineteenth century, the practice of coin collecting became so widespread that an active commercial market developed where an informal network of dealers bought and sold coins to interested individuals.

Recently, as the prices of rare coins have increased, collectable coins have become a medium of investment. This has produced dramatic changes in the way business is conducted within the numismatic marketplace.

One of these changes is the widespread use of the Sheldon incremental coin grading scale. Historically, an expression of a coin's state of preservation or its “grade” was limited to a descriptive range beginning with a grade of GOOD and ending with a grade of UNCIRCULATED. The succession of traditional descriptive grades read as follows: good (G); very good (VG); fine (F); very fine (VF); extremely fine (EF); about uncirculated (AU); uncirculated (UNC) or mint state (MS). In contrast, when using the Sheldon coin grading scale, a coin's state of preservation is further defined on a numeric scale in which “1” represents the worst possible condition and “70” represents the best possible state of preservation. Widespread adoption of Sheldon's expanded method for grading collectible coins has intensified the standards of grading. Methods, systems, and mechanisms for objectively grading and identifying coins are described in the U.S. Pat. Nos. 4,899,392; 5,220,614; 5,224,176; and 5,494,147, for example.

A coin's grade contributes greatly to its market value. In many instances, a very slight difference in grade can correlate to a large difference in value. As a general rule, the market value of a collectible coin tends to increase non-linearly with incremental increases in grade. Consequently, a coin which exhibits a high state of preservation, that is to say, a pristine coin that remains MINT STATE having never circulated will likely command a market price many times higher than the same coin grading AU58. During day to day commerce, a coin's state of preservation decreases due to normal handling by the public. A drop in grade from MS66 to EF45 can at times translate to a non-linear reduction in market value extending throughout the full range of grades down to G04 and below. For certain specimens, uncirculated examples may be so scarce that less than a few are known to exist. In these rare instances, as much as 90% of the coin's potential market value resides in being classified as MINT STATE (MS60 through MS70). For extremely rare and highly sought after coins, a difference of only a few points within the uncirculated category can effect market value by thousands of dollars.

Another change that greatly influenced the numismatic marketplace was the introduction of encapsulated coins graded by an independent third party. As the numismatic marketplace began to use the expanded Sheldon grading scale, concern regarding the reliability of grading within the market increased. Market participants soon learned that a coin grading MS65 may have a market value many times greater than the same coin grading MS64, although the distinction may not be readily discernible to the untrained eye.

A coin purchased by a dealer as MS64 might be sold to a collector as MS65 affording the dealer a considerable profit. Due to the absence of a true method for certifying a coin's grade, the average collector was often victimized by product misrepresentation. Industry leaders were deeply concerned that without consistent grading the rare coin market would suffer and likely diminish overall. In 1985, a group of notable coin experts banded together and formulated a plan to create a professional third-party coin grading service. The advent of the third-party appraisal of a coin's physical condition, backed by a guarantee, and a national network of coin dealers provide a reliable form of consumer protection. In addition, the Professional Coin Grading Service (PCGS) popularized a method of encapsulation that gave the rare coin consumer added transactional security.

A case of the type commonly used to encapsulate coins is described in the U.S. Pat. No. 5,042,650 to Mayer and Hall, titled Tamperproof Coin Case. This patent describes a rigid plastic coin case having two interlocking plastic plates ultrasonically sealed together to form a tamper proof and protective enclosure for collectible coins. Since the introduction of encapsulation, it has become known to those skilled in the art that the rigid plastic holders described by Mayer and Hall are not as tamperproof as the original term of art may have suggested. It is understood and appreciated by those skilled in the art that a practice known as “cracking-out” occurs so routinely in the marketplace that it has now become customary to refer to such rigid plastic protective holders as “tamper-evident rather than “tamperproof” or” “tamper-resistant”. With respect to the aforementioned change in vernacular, one should not misconstrue nor underestimate the effectiveness of past and present coin encapsulation methods. Rigid “tamper-evident” coin cases having interlocking plastic plates ultrasonically sealed together are no easier to defeat than those previously characterized as “tamperproof” or “tamper-resistant”. Therefore, the term “tamper-evident” as it relates to the art of encapsulating coins in rigid plastic holders shall be construed herein to have the more current, generally accepted, ordinary and accustomed meaning in the art.

The popularity of third party grading coupled with the practice of encapsulating only authentic coins within tamper-evident (formerly “tamperproof”) plastic holders revolutionized the numismatic market. Authenticated coins, encapsulated in plastic and certified as to grade soon began to move in the marketplace as almost fungible commodities. At present, it is not uncommon for buyers and sellers to consummate trades without the buyer having physically examined the coin. In fact, this marketplace is established to the extent that near real time quotes are available with relative price spreads (BID vs. ASK) for all but the most rare and unique specimens.

Despite these developments, prudent buyers who invest significant sums on individual coins typically do not purchase expensive pieces sight-unseen. While traded sight unseen, coins have too much individual identity to be a fungible commodity. Thus, the coin shows that are organized on an almost weekly basis around the United States, remain the forum where many collectors examine coins before committing to a purchase. A coin show gives both dealers and collectors the best opportunity to examine currently available material.

The development of easily accessible electronic commerce, such as through the Internet, was quickly adopted by individual coin collectors in the sight-unseen coin market. In addition to significantly increasing the size of the marketplace and eliminating the time lag that exists in print publications, electronic commerce permits individual coin collectors to act as dealers whenever it suits them. Historically, individuals opting to participate within the coin market as dealers had to pay a high price for admission. Initial inventory, advertising expenses, direct mailing costs, travel, lodging and a storefront all contributed to high startup costs.

Alternatively, by using electronic commerce, any collector can become a part-time coin dealer selling coins he owns via any of the readily available on-line auction services, for example. Such auction services and even more informal bulletin boards permits any collector to sell his coins at near retail level to another collector rather than to an established dealer at a considerable discount. As a consequence, an invigorated and rapidly growing sight-unseen coin market has evolved in “cyberspace” and the once clear differentiation between dealer and collector has become blurred.

However, unlike a coin show where one can walk the floor and browse, the nature of the sight-unseen market often impedes a collector's natural tendency to “hunt” for undergraded bargains or “cherrypick” rare die varieties from the inventories of dealers who lack such knowledge. These activities usually require close physical proximity to a plentiful selection of coins, a circumstance that is impossible given the unique logistic nature of the sight-unseen coin market. Furthermore, experienced coin collectors and dealers realize implicitly that the process of accurately grading and pricing a coin depends on careful physical examination. Such examination is usually carried out with the aid of a jeweler's loupe or magnifying glass. The traditional sight-unseen market makes it difficult for new collectors to develop a feeling for how collectable coins are examined, graded and priced. Individual self-reliance with respect to grading rare coins is an absolute necessity for increasing the number of collectors willing to invest in quality coins. Therefore, it would be desirable to offer novice buyers and sellers a more favorable sight-unseen marketplace environment where the exchange of numismatic material sight-unseen could be carried out in a virtual marketplace experience that would present an abundant offering of virtual coins for buyers to carefully examine at will, each coin capable of being inspected interactively as if under simple magnification.

The rapid growth and increase in popularity of eBay™ as well as other online person-to-person trading venues has invigorated the sight-unseen coin market. Nevertheless, solving the image delivery needs of on-line buyers and sellers addresses only one marketplace requirement. What is still clearly needed is a well-structured and more streamlined on-line trading environment for graded encapsulated objects.

Despite the growing popularity of online peer-to-peer trading within the numismatic marketplace, participants (sellers and buyers) continue to struggle with sub-optimal trading mechanisms. The present invention strives to address the needs of marketplace participants by providing an improved means for trading graded encapsulated objects.

The methods and processes of the present invention may be differentiated from other art presently known by its ability to serve as a novel transaction enabling and technologically advanced information exchange platform supporting the interaction of buyer and seller activities in real time.

### GLOSSARY

Contained herein are references to “tamperproof”, “tamper proof”, ” “tamper-resistant” and “tamper-evident”. It is to be understood that terms such as these may be used interchangeably throughout this disclosure. It is now recognized and appreciated by those skilled in the art that the term “tamper-evident” has superseded the use of the term “tamperproof” or “tamper proof” or “tamper-resistant” as it relates to the rigid plastic holders which are customarily used to encapsulate collectible coins and the like.

Contained herein are references to “online auctions”, “auction Web sites”, “auction facilities”, “person-to-person trading venues”, etc. It is to be understood that terms such as these may be used interchangeably throughout this specification. Additionally, it is well known that eBay™ prefers from time to time to define itself as a venue engaged in “person-to-person trading” or as an “online trading site.” For purposes of clarity, the term “online auction” shall be construed to mean any auction-style peer-to-peer trade offer supported by a “trusted” facility accessible via the World Wide Web component of the Internet. The aforementioned definition of an “online auction” shall therefore be construed to have the ordinary and accustomed meaning in the art. Any reference herein to “marketplace computer”, “online auction service”, “auction facility”, “auction Web site”, person-to-person trading venue” and the like shall be construed to have similar meaning within a peer-to-peer trading environment and shall be non-limiting with respect to interpretation or scope. The above referenced terms serve as representative examples not an exhaustive glossary. Therefore, other similar terms not specifically mentioned above may be known equivalents in the art and if used herein shall in no way constrain the scope of the present invention.

### SUMMARY OF THE INVENTION

In one embodiment, the present invention concerns a system and method for creating a more robust virtual marketplace for examining coins with linked multiple images of each coin being offered for sale. Such linked multiple images, referred to hereinafter as a coin image compilation are stored on a host computer system that is remotely accessible. A prospective buyer can access the host computer and review the coin image compilation to examine the visual appearance of any coin he wants to buy.

One aspect of this embodiment of the present invention comprises a computer system for selectively displaying a coin image compilation where the coin image compilation comprises a plurality of linked “views” representing different resolutions of the original image and tiled sub-images of the entire image. The computer system in this embodiment comprises a host computer; a data storage device operatively connected to the host computer for storing the coin image compilation, a remote terminal that can connect to the host computer to access the coin image compilation; a display device connected to the remote terminal; and an input device connected to the remote terminal for selecting for display on the display device from the data storage device a selected “view” corresponding to a predetermined resolution and number of tiles.

Another aspect of the invention is a computer system for selectively generating coin image compilations. This computer system comprises a HTTP (Hypertext Transfer Protocol) host computer; at least one data storage device operatively connected to the HTTP host computer; data for multiple images of the coin image compilations stored on the at least one data storage device; a remote terminal capable of reading and rendering HTML (Hypertext Markup Language) pages that can connect to the host computer; a processor mounted on the HTTP host computer that generates successive dynamic HTML pages on-the-fly from the data and streams the dynamic HTML pages to the remote terminal as requested by the remote terminal.

Still another aspect of the invention is a method for selectively viewing coin image compilations on a remote terminal connected to a host computer where the coin image compilations comprise images 1, 2, 3, . . . N of an obverse view, a reverse view, and a holdered view, the method comprising the steps of: a) connecting the remote terminal to the host computer; b) querying a database of the coin image compilations on the host computer from the connected remote terminal; c) selecting a coin image compilation from the queried database; d) sending the image 1 of the obverse view, the reverse view, and the holdered view from the host computer to the remote terminal; e) displaying the sent image 1 of the obverse view, the reverse view, and the holdered view at the remote terminal; f) selecting any displayed image; g) requesting one of images 2 through N of the selected image from the host computer; h) sending the requested one of the images 2 through N from the host computer to the remote terminal; i) displaying the sent image at the remote terminal in place of the selected displayed image; and j) repeating steps f) to i) as desired.

In the above-described embodiment, the present invention provides access to linked multiple views of each of a plurality of coins being offered for examination or sale, i.e. a coin image compilation (CIC) for each such coin. When the coin has been certified and encapsulated by an independent third party grading firm, the CIC is known as a Certified Coin Image Compilation (CCIC). It is understood that third party coin grading firms are uniquely positioned within the marketplace, and possess the requisite level of credibility, making them preferred candidates to practice this and other aspects of the present invention, but practicing the present invention is in no way limited to third party grading firms.

Recognizing the important role which third party grading services play within the numismatic market, it should be stated that an object of the present invention is to provide an improved business model for existing third party grading firms where the internal and external deployment of a well developed Numismatic Imaging Protocol such as the Certified Coin Image Compilation disclosed herein may better serve the collective best interests of all market participants.

Accordingly, it is one object of the present invention to provide a well developed Numismatic Imaging Protocol for the numismatic industry where the deployment of such protocol can be used internally within third-party grading firms to increase the productivity and consistency of expert coin graders employed by such firms.

Accordingly, it is an object of the present invention to leverage the inherent power of the World Wide Web's distributed content characteristic by providing a system, apparatus and method for Certified Coin Image Compilation whereby the invention's unique graphic layout and coin image presentation can be linked to and displayed simultaneously in conjunction with independent attempts by numismatists to offer coins for sale via the World Wide Web.

Accordingly it is an object of the present invention to overcome prior art limitations by providing novel technology that uses network bandwidth efficiently, making it possible for a third party grading firm to present image-rich, responsive Web pages that access high-quality, high resolution data for zooming in on and exposing fine image details of collectible coins having been authenticated, graded and encapsulated by the firm.

It should therefore be stated that another object of the present invention is to provide an improved method for encapsulating collectible coins where the application of a World Wide Web address (URL) in a substantially permanent manner to an encapsulated coin's protective case or the addition of like identifying indicia within the rigid plastic “tamper-evident” protective holders provided by third party grading firms facilitates the utilization of Certified Coin Image Compilations within the virtual numismatic marketplace.

Accordingly, it is another object of the present invention to provide a well developed Numismatic Imaging Protocol for the numismatic industry where the external deployment of such protocol by a third party grading firm may lead to a beneficial increase in the overall goodwill and aggregate added value associated with a least one third party grading firm's installed base of encapsulated coins.

Another object of the invention is to provide an apparatus and method for matching remotely located buyers and sellers of numismatic material through the use of a computer system that permits a prospective buyer to select an item of interest and examine it in detail via multiple linked images or “views”.

Additionally, it is an object of the present invention to overcome the technical and financial impediments facing numismatist by providing an apparatus, method and system whereby prospective sellers of numismatic material can best present visual and textual information pertaining to their coins without the need to possess HTML coding skills, expensive photographic equipment or access to a Web server.

Accordingly, it is an object of the present invention to provide an apparatus and method for matching buyers and sellers of numismatic material through a data communications network wherein the system offers: readily available online access to a host system containing a plurality of numismatic items; online search capabilities permitting a prospective buyer to select an item of interest based on a plurality of user defined search criteria; displaying the resultant item according to a unique identification number; providing the prospective buyer with a novel, high-resolution interactive display defined herein as a Certified Coin Image Compilation.

Accordingly, it is yet another object of the present invention to provide an apparatus and method providing educators, writers, researchers and the like with pertinent numismatic information through a data communications network wherein the system offers: readily available online access to a host system containing a plurality of numismatic items; online search capabilities permitting a researcher to select an item of interest based on a plurality of user defined search criteria; displaying the resultant item according to a unique identification number; providing the numismatic researcher with a novel, high-resolution interactive display defined herein as a Certified Coin Image Compilation.

Accordingly, it is another object of the present invention to provide a well developed Numismatic Imaging Protocol for the numismatic industry where the utilization of high resolution visual documentation in conjunction with collectors' offer to sell coins raises in a measurable way transactional efficiency within the coin market.

With respect to trading graded encapsulated coins online, it is well known in the art that the presentation of one or more displayed views of a coin improves the overall online trading experience for potential buyers (bidders). Therefore, it is preferred that the present invention include at least one image or “view” of each graded encapsulated coin to be offered for sale so as to better facilitate the exchange of such objects within an online peer-to-peer trading environment. It is understood that in addition to the graphic information of the images of the coin, a coin image compilation may also contain textual information regarding the coin and that this information may be independently searchable. Textual information regarding graded encapsulated U.S. coins may include a year of mintage indicator (e.g. “1845”); a Mint branch indicator (e.g. “O”) indicating where the coin was manufactured; a denomination indicator indicating the monetary face value of the coin (e.g. “50 cents”); a coin type designation (e.g. “Liberty Seated Half Dollar—No Motto 1839-1866”); a grade indicator indicating the assigned grade of the coin (e.g. “MS63”); and a grading firm indicator (e.g. “PCGS”) identifying the entity or individual assigning a grade to the coin. It is to be understood that the aforementioned textual information may also be defined collectively as “relevant trade data” wherein said “relevant trade data” may be used to facilitate the exchange of graded encapsulated objects. With respect to the present invention, it is to be understood that data (including metadata) representing transaction histories such as “prices-realized” and computed fair market values may additionally or alternatively be regarded as “relevant trade data”.

Therefore, an exemplary embodiment of the present invention may facilitate the computation, retrieval, and display of fair market values for certain graded encapsulated coins. The present invention may be practiced in alternative ways so as to facilitate the computation and/or determination of fair market values for logical groupings of graded encapsulated coins as well. For example, when an identified grouping of graded encapsulated U.S. coins share common characteristics such as date, denomination, mintmark, grade, and/or grading firm, such “common” characteristics may be assessed in various combinations for one or more purposes including market valuation and analysis.

It is generally accepted that the average sales price (i.e. average price-realized) for graded encapsulated coins that share “common” characteristics such as date, mintmark, denomination and grade constitute fair market value provided the method of gathering the individual price-realized peer-to-peer trade data is credible. In order for such data to be viewed as credible, it is important that the source or sources of such “relevant trade data” fairly represent market demand. Additionally, it is important that the gathered prices-realized data and the method providing for the computation of fair market valuation be statistically valid as well. Fair market values for U.S. coins have traditionally been reported via printed periodicals known in the art as price guides. The Red Book, Coin World Trends and The Coin Dealers Newsletter to name a few, each serve as an independent source for determining coin values. Close comparison often shows significant differences. In order to reduce uncertainty in the marketplace, it is important that an information source be credible and represent known transactions within the marketplace. Those skilled in the art realize that from time to time undesirable sources seek to strategically improve the bargaining position of sellers by overwhelming the market with information (i.e. advertising) that is designed to artificially inflate prices/offers for selected U.S. coins. Such attempts tend to unfairly skew price characteristics and undermine the economics (i.e. supply vs. demand) operating within a fair market.

Large well-established online auction facilitators such as eBay™ for example, provide substantial transactional frequency and therefore better represent the market dynamic operating within the U.S. rare coin marketplace. With respect to the present invention, showing that fair market values are computationally determined from empirical trade data is an important step toward assuring that future marketplace price guides will better document market demand for certified U.S. coins. Those skilled in the art will recognize and appreciate that the development of a comprehensive database linking physical graded encapsulated objects with trusted empirical peer-to-peer transaction data is desirable. Therefore, it is an object of the present invention to provide a system, apparatus and method providing an information bridge linking selected graded encapsulated objects with empirical trade data.

The gathering of prices-realized data including metadata associated with the sale of graded encapsulated objects may be accomplished in any number of ways or variations. For example, those skilled in the art of HTML programming and HTTP server configuration will readily recognize and appreciate that online auction facilities (Web sites) can be queried directly using text based search criteria. In many instances the administrators of popular online trading facilities (Web sites) offer unimpeded access to their “site specific” search capabilities and provide such search capabilities directly to the viewing public or at least to the site's registered users. Established online auction sites such as eBay™ for example, offer users the benefit of well-conceived search pages where users can perform simple keyword as well as more complex full-text searches. A market information source such as eBay™ is deemed a statistically credible information source because (among other things) it is sufficiently large. Large-scale peer-to-peer trading venues provide analysts with sizable samples thereby allowing the analysis of data associated with specific groupings of graded encapsulated objects to be statistically valid.

Ultimately, it may be desirable for individual online peer-to-peer trade participants to arm themselves with effective data sampling tools enabling the participants to generate accurate market demand estimates using their own initiative. Nevertheless, even if such data sampling tools were widely deployed, a glaring limitation would persist. Despite the pervasiveness of certificate numbers printed and sealed within millions of graded encapsulated objects, the utilization of a certificate number or other unique identifying indicia associated with a graded encapsulated object has heretofore been unknown and absent from existing online search methodologies. Strategies for gathering (or disseminating) market price information from sources such as eBay™ for example, will always exhibit an unwanted degree of inadequacy until such time that unique identifying indicia such as certificate numbers are effectively gathered by the online trading facility or its designee. Correspondingly, a strategy for gathering grading firm identity data and gathering associated grade indicator data will similarly enhance the data gathering and dissemination methods disclosed herein.

An exemplary embodiment of the present invention includes search criteria where the retrieval of data representing fair market values and “prices-realized” information for graded encapsulated objects (e.g. encapsulated U.S. coins) may be facilitated by the inclusion of said unique identifying indicia within the command syntax of a keyword search, database query, URL request, or other forms of selection criteria. An embodiment of the present invention may further include the dissemination of data representing fair market values and “prices-realized” information wherein such data is uniquely associated with certain graded encapsulated objects (e.g. certain U.S. coins). In addition to being specifically associated with a certain graded encapsulated object, it is to be understood that the gathering and dissemination of data representing fair market values and “prices-realized” information for such an object may also take the form of an average price wherein said average price is determined computationally from an aggregation of data representing multiple subsequent transactions specific to a unique graded encapsulated object. Correspondingly, a calculated average sales price (fair market value) may also be computed from an aggregation of known “prices-realized” data wherein the aggregation of price data is comprised of like graded encapsulated objects (e.g. encapsulated U.S. coins) sharing “common” characteristics including date, mintmark, denomination, grade and/or grading firm, for example.

Accordingly, the present invention encompasses all data forms including search criteria wherein the gathering and dissemination of “relevant trade data” associated with graded encapsulated objects (e.g. graded encapsulated U.S. coins) is facilitated by the utilization of unique identifying indicia.

Furthermore, the present invention encompasses all methods including data search methods wherein the gathering of “prices-realized” information and the calculation of fair market values associated with graded encapsulated objects (e.g. encapsulated U.S. coins) is facilitated by the utilization of unique identifying indicia.

Accordingly, it is to be understood that fair market valuation for graded encapsulated objects (e.g. coins) may be calculated mathematically by averaging the “prices-realized” data gathered and aggregated from a plurality of transactions specific to a single certain unique encapsulated graded object.

Accordingly, a calculated fair market value (i.e. average sales price) may also be computed from an aggregation of known “prices-realized” wherein the aggregation is comprised of graded encapsulated objects which share “common” characteristics including grade and grading firm.

Recognizing the important role which third party grading services play within the numismatic marketplace, it should be stated that it is an object of the present invention to provide an improved business model for existing third party grading firms where the capture, storage and subsequent transmission of “relevant trade data” to an online trading venue in a predetermined manner may better serve the collective best interests of all market participants.

It is generally accepted and appreciated that third party grading firms remain at-arms-length with respect to trading. This restriction ensures that their contribution to the marketplace and their grading practices remain unbiased. In keeping with the spirit of this self imposed market behavior, the present invention if practiced by third-party grading firms can successfully preserve the anonymity of coin owners without departing from the present invention's spirit or scope or limiting its use or practice elsewhere within the market.

Accordingly, it is an object of the present invention to leverage the inherent power of the World Wide Web's distributed content characteristic by providing a system, apparatus and method whereby “relevant trade data” associated with certain graded encapsulated objects can be linked to and displayed simultaneously in conjunction with independent attempts by online marketplace participants to offer graded encapsulated objects for sale via the World Wide Web.

It should therefore be stated that another object of the present invention is to provide an improved method for encapsulating collectible objects where the application of a World Wide Web address (URL) in a substantially permanent manner to an encapsulated object's protective case or the addition of like identifying indicia within the rigid plastic protective holders provided by third party grading firms facilitates the retrieval and/or transmission of “relevant trade data” associated with certain graded encapsulated objects thereby providing marketplace participants with a more streamlined means for listing and ultimately exchanging such objects.

Another object of the present invention is to provide a system, apparatus and method for matching remotely located buyers and sellers through the use of inter-connected computers wherein prospective buyers may select or otherwise search for an object of interest using one or more “relevant trade data” elements known to be associated with an object of interest.

Additionally, it is an object of the present invention to overcome technical and financial impediments facing online trade participants by providing “trade ready” graded encapsulated commoditized objects whereby prospective sellers can best present visual and textual information in a predetermined manner for review within one or more established online trading venues.

Accordingly, it is another object of the present invention to provide an integrated market exchange system, apparatus and method facilitating trade in graded encapsulated commoditized objects wherein transactional efficiency within relevant markets is raised in a measurable way by practicing the present invention.

### LIMITATIONS OF THE PRIOR ART

### Part One: eBay™

Popular online auction Web sites such as eBay™ for example, exhibit a tremendous amount of critical mass. Much of the success of eBay™ is certainly attributable to its broad appeal. By offering users (buyers and sellers) an ever-expanding horizon of items for sale, eBay™ has managed to amass a significant audience of users for virtually any conceivable item. With respect to search criteria and selection methodology, eBay™ has pre-defined for the benefit of users a categorization hierarchy (schema) for virtually any item offered for sale on its Web site. Full-text and keyword search methodologies executed by users wishing to search the entire active Web site continue to work with speed and responsiveness. Likewise, more robust title and description keyword searches restricted to specific categories exhibit similar levels of speed and efficiency when executed. There are however some noteworthy limitations.

It should be noted that eBay™ does not provide registered users with perpetual access to “closed” auction pages. It has been a traditional practice for eBay™ to take completed auctions “off-line” following the 90 day anniversary of the auction's closing. It is reasoned that in the case of eBay™, the cost associated with maintaining perpetual access to all of its trade listings is prohibitive. Even if eBay™ desired to reverse course and maintain an active archive of “closed” auctions for one or more purposes including the implementation of a “prices-realized” database of encapsulated graded objects, aggregation of the individual trade listings would be difficult at best without first adhering to the unique teachings disclosed herein. To illustrate the aggregation challenge facing a peer-to-peer trading venue such as eBay™, consider the case of a popular and highly sought after U.S. coin. A 1909 S VDB Lincoln Cent is known by even casual U.S. coin collectors to be a “KEY DATE” within the Lincoln Cent series. Using eBay's search mechanism for example, and launching a search using a search string equal to “1909 S VDB” will provide the searcher (user) with a display of the current auctions (trade listings) in which the search string is present. Similarly, the “1909 S VDB” search string may be used to isolate only “completed” fixed-price or “closed” auction-style trade listings. Recently, eBay™ eliminated from one of its predefined search pages the “completed” auction search option. Users must now drill deeper into the site and use the “advanced” search option wherein users are given the ability to query the Web site for “completed” trade listings. This now presents an obstacle to less sophisticated individual users wishing to construct (for their own fair use) a price history for items of interest. In the past, when the search page offered users an obvious option to isolate “completed” trade listings, the resultant page display provided the searcher with a number of recently (30 days or less) “closed” listings for review. Nevertheless, and unfortunately, there is no straightforward means to determine the average price realized for the 1909 S VDB Lincoln Cent trading on eBay™ or for that matter the average price realized for any collectible U.S. coin offered for sale within eBay's peer-to-peer trading environment (auction facility). Simply stated, the eBay™ trading facility (Web site system) does not “operate” mathematically upon high bid amounts for the purpose of determining an average price realized or an average fair market value. Despite its importance, eBay™ does not provide pertinent information for the benefit of market participants desiring access to fair market values.

For eBay™ users, the information retrieval problems are further exacerbated by the fact that a collectible object's “condition” (it's assigned grade) is of paramount importance toward determining a fair market value for the object. In order to be useful, fixed-price results and auction results (“prices-realized”) need to be further segregated by grade. In the case of certain graded encapsulated U.S. coins for example, it is preferred that such segregation should (at a minimum) follow the Sheldon coin grading scale. It is to be understood that eBay™ does not capture or store individual “relevant trade data” elements (fields) such as date, denomination, mintmark, assigned grade, and/or grading firm.

The present invention addresses these and other problems by providing an apparatus, method and system for capturing and disseminating the results (high bids) of selected “closed” online trade listings so that a comprehensive grade specific “prices-realized” database may be made available to marketplace participants. Preferably such data would be available for viewing on the auction facility's Web site directly or alternatively, indirectly via embedded hypertext links.

### LIMITATIONS OF THE PRIOR ART

### Part Two: Numismatic Database Management Systems

Within the numismatic marketplace there is a large installed base of computer systems wherein each system adheres to its own database schema for collectible coins. For example, well-established and “trusted” third party coin grading firms each maintain their own proprietary information systems wherein specific details pertaining to millions of individually graded coins are known to be stored. However, at the time of this writing, no currently operating third party grading firm is known to provide network access to their proprietary information systems for the purpose of serving assigned unique associated high-resolution coin imagery, relevant peer-to-peer trade data or relevant exchange metadata to the public. Of some interest however, is a verification method made available by the Professional Coin Grading Service, Inc. Deployed in the summer of 1999 PCGS offered eBay™ sellers and others an opportunity to link to a PCGS controlled Web server for verification purposes relating to coins having been graded and encapsulated by PCGS. Despite this development, it is understood by those skilled in the art that PCGS does not provide Internet Web access to a comprehensive database of trusted coin images or other relevant information specifically relating to the exchange of certain coins encapsulated and graded by PCGS. The PCGS online search mechanism provides only limited textual data corresponding to coins previously certified as to grade. What is clearly needed is access to additional information including trusted high-resolution imagery, auction history, and price realized data as well as user-friendly means for retrieving and viewing such information. The present invention strives to overcome these limitations by providing an integrated solution.

One aspect relating to the present invention concerns the development of a relational database system to be used in conjunction with trusted certified coin image compilations and relevant metadata associated with graded encapsulated U.S. coins. Databases require a consistent structure, termed schema, to organize and manage information. In a relational database, the schema is a collection of tables. For each table, there is generally one schema to which it belongs. In an implementation of a relational database, a relation corresponds to a table having rows, where each row corresponds to a tuple, and columns, where each column corresponds to an attribute. From a practical standpoint, table rows represent records of related data and columns identify individual data elements.

In order to further overcome some limitations within the prior art the widespread deployment of a well-conceived database schema for U.S. coins is deemed desirable. Toward that goal, an exemplary U.S. coin database schema consisting of four tables will now be discussed.

First, the structure of an exemplary COINTYPE table is defined, wherein each record contains a unique description of a U.S. Coin Type. (See Appendix 1a at pages A1-A2)

Second, the structure of an exemplary DENOMINATION table is defined, wherein each record contains a unique DENOMID field, a unique DENOMVALUE field, and a DENOMINATION field specifying a broad “type” description for each record. (See Appendix 1b at page A3)

Third, the structure of an exemplary MINTMARK table is defined, wherein each record contains a unique MINTMARKID field, a unique MINTMARK “character” field, followed by a unique MINTNAME “character” field specifying the geographic location (city) where a given U.S. coin was minted. (See Appendix 1c at page A4)

Fourth, the structure of an exemplary U.S. coin MASTER table is defined, wherein each record contains a MINTYEAR field, a DENOMID field, a COINTYPEID field, a MINTMARKID field, followed by a VARIETY field specifying a unique coin variety when known or otherwise applicable to the art of numismatics. (See Appendix 1d at pages A5-A69)

In a well-conceived relational database system, one can add a new column to a table without having to modify older applications that access established columns in the table. Similarly, one or more new records can be appended to a table without affecting the underlying schema of the database system. This is especially evident when a relational database of U.S. coins is considered. For example, each year the U.S. Mint produces new coins for circulation. Consequently, each year additional coins (database records) will need to be appended to the MASTER table in order to keep the system up to date. Relational databases are desirable because they provide flexibility to accommodate changing needs. Once the schema is designed, a tool, known as a database management system (DBMS), is used to populate the database and to operate on data contained within the tables. The DBMS stores, retrieves and modifies data associated with the database, and to the extent possible it serves to maintain information integrity and protect data from loss or corruption.

In practice, digital images stored as graphic files usually reside beyond the established boundaries of a database schema. When this is the case, such graphic format files (e.g. jpeg graphic format files) tend to exist as stand-alone files each being stored by reference within a common directory structure, with each file being uniquely named and/or adhering to a uniquely defined path. Numerous naming conventions for digital graphic files have been practiced with alphanumeric serialization being the most common method utilized by systems analysts skilled in the art of relational database design.

Within a relational database system, a single table can be used to reference each image file or other associated “relevant trade data” including relevant metadata being stored within the system. In this way, digital images, online prices-realized and other relevant trade data including metadata may be stored and subsequently retrieved by reference without first requiring a user to have specific prior knowledge of the unique identifying indicia (e.g. certificate number, URL, bar code, or file name) physically associated with an encapsulated object, for example.

To further illustrate the application or assignment of a file naming convention for U.S. coins, consider the case of the 1893 S Morgan Dollar. Although it may be anticipated that such a coin for example is encapsulated in a tamper-evident holder and that such a holder contains a printed certificate bearing an assigned unique certificate number, the coin can also be “generically” identified by using a text string such as “189311317414”. Close examination shows that the first four characters represent the year of mintage, the next three characters represent the DENOMID pursuant to the herein disclosed database schema, the next three characters represent the COINTYPE designation pursuant to the herein disclosed database schema, the last two characters represent the MINTMARKID designation pursuant to the herein disclosed database schema.

Using the structure of the herein disclosed numismatic database schema a developer skilled in the art may create and may implement a powerful, user-friendly U.S. coin search engine. For example, a user could simply start the search process beginning with a first step wherein the user is prompted to select a year between the range of 1793 and 2003 for example. In response, the search engine would logically return an additional selection list containing only the coin types valid for the chosen year. The user would then be prompted to select any one of the presented coin types relevant to the chosen year. Once a coin type is selected the search engine would present the user with a selection list of valid mintmarks known to be specifically associated with the relevant “year” and “coin type” already chosen. Search engine functionality based on the aforementioned drill-down approach is user friendly as well as intuitive. Alternative embodiments are also possible. For example, a seller wishing to list a U.S. coin on eBay™ (or any peer-to-peer trading venue) may be prompted to utilize a data capture method equivalent to the aforementioned drill-down approach to indicate to the trading facility the “relevant trade data” associated with the U.S. coin he wishes to list including item specific attributes such as date, denomination, mintmark, grade, and/or grading firm. In one embodiment of the present invention, the storage of item specific attributes such as date, denomination, and mintmark for collectible U.S. coins may constitute the minimum “relevant trade data” necessary to initiate an on-line peer-to-peer trade listing. Of course the minimum “relevant trade data” necessary to initiate a trade listing within any one of many trading venues is largely dependent upon the unique data structures established by each trading facility. Thus the minimum “relevant trade data” necessary to establish a trade listing may differ according to the data storage capacity, data listing preferences, or other pertinent criteria established by each online trading venue.

Although the above illustrated database schema and drill-down search methods for U.S. coins are recognizably intuitive, they are not necessarily easily anticipated by numismatists skilled in the art of relational database design. The ingenuity of this aspect of the present invention lies in its ability to compliment customary database schema with a single well conceived file naming convention using a simple string of numeric (or alpha-numeric) characters. This inventive concept can transcend the design and implementation of traditional relational database schema. It should be understood that the exemplary file naming convention discussed herein can be employed in various ways and within various embodiments of the present invention without forcing the scope of this inventive concept to be limited to the implementation of relational database functions or methods. For example, an exemplary URL such as http://www.virtual-bourse.com/189311317414.html defines a Web page that pertains to the 1893 S Morgan Dollar. Thus, the illustrated file naming convention discussed herein can prove useful even within a static HTML environment where dynamic database connectivity is not required or otherwise not utilized.

Widespread adoption of a standard numismatic database schema can lead to many other unanticipated benefits as well. Coin dealers buying short-term space (renting tables) at a well-attended coin show may in the future be given access to a wireless local area network wherein for example, Wi-Fi enabled laptop computers may be pre-loaded with the dealers' current “for-sale” inventory and the data uploaded to the show's main file server (host computer). By using a common search engine and/or database schema, the participating dealers (including the collecting public in attendance) could review the consolidated inventory of “for-sale” items. If the “for-sale” items include encapsulated coins that have been imaged according to the teachings of U.S. Pat. No. 6,366,899, then the examination of trusted high-resolution images could also be possible. Locating encapsulated coins of interest without first having to visit each dealer's table saves valuable time. Instant messaging between participants could be allowed and integration with a live locally held auction could also be provided. Additionally, the organizer(s) of the coin show could also provide wireless network access to the Internet where dealers could simultaneously promote their offerings via any available online auction-style listing service such as eBay™ for example. Under such conditions, it is also anticipated that the use of wireless PDA's, Web enabled cellular phones and the like will become ubiquitous.

As discussed herein, a common numismatic database schema can support and facilitate the integration of various seller actions including actions that may be undertaken to list an item for sale on a peer-to-peer trading venue. Additionally, a common numismatic database schema can support and facilitate the integration of various coin show activities thereby providing marketplace participants with improved access to valuable information including “prices-realized” data. Improved access to valuable “prices-realized” data will likely lead to improved transactional efficiency. Heightened levels of transactional efficiency generally impact fair markets favorably.

### LIMITATIONS OF THE PRIOR ART

### Part Three: HTML Parsing Software Applications

With respect to the present invention, this disclosure would not be complete without a discussion relating to HTML parsing techniques. In practice, there are a number of terms that describe HTML parsing such as Web site “data mining” and Web site “scraping” for example. Of some interest is a client-side software application marketed by GemDev (www.gemdev.com) and titled MAJORPRICE. Appendix 2 (at pages A70-A71) shows an exemplary screenshot advertising the main page of version 2.0 of the MAJORPRICE software. The MAJORPRICE software is designed to operate upon the eBay™ auction Web site exclusively. The software includes an embedded browser framed within the boundary of the application's client window. The embedded browser is capable of accessing “live” eBay™ data in real time just as a stand-alone full display Web browser would. The GemDev MAJORPRICE client-side tool is intended to operate on “closed” auction data in an attempt to compute an “average end price” on the fly. Recently a category specific searching filter has been added to this tool's functionality. The search method employed by MAJORPRICE is text-based and capable of returning results in real-time from “live” eBay™ data. The returned results of a text-based (or keyword) search are imported into a client-side grid and further manipulated. In comparison to the present invention, the MAJORPRICE client-side application is fundamentally flawed because it is subject to the same errors, omissions, inadequacies and limitations as the eBay™ auction Web site itself. Specifically, eBay™ (and MAJORPRICE) users continue to struggle with an information retrieval problem that is exacerbated by the fact that an encapsulated object's “condition” (it's assigned grade) is not easily parsed given the earlier cited limitations of the current eBay™ system implementation. As stated, in order to be useful, auction results (“prices-realized”) need to be carefully segregated by grade. Preferably, such segregation should be determinate and accurately reflect the grading scale that has been adopted by the established third-party grading firms. The present invention addresses these and other problems by providing an apparatus, method and system for gathering and disseminating the results (high bids) of selected “closed” online auctions so that a comprehensive bias corrected, grade specific, “prices-realized” database can be made available to marketplace participants.

### LIMITATIONS OF THE PRIOR ART

### Part Four: Online Price Guides

Online numismatic price guides are emerging and generally serve as adequate substitutes for traditional printed price guides such as Red Book, Coin World Trends and The Coin Dealers Newsletter. One grading firm, namely PCGS offers an online price guide that is similar in presentation to traditional printed price guides. Another online price guide gaining popularity is available at www.numismedia.com. Coin World, a popular and well-established weekly print publication also offers. an online price guide. The above mentioned online price guides present static “spreadsheet” views and lack any direct search capability linking fair market values to empirical trade data. With respect to related prior art, the present inventor knows of only one online fair market value system that links specific U.S. coins to empirical prices-realized data. An eBay price wizard marketed by www.worldcoinsprices.com a Brazilian software enterprise uses an Internet Explorer third-party browser extension allowing users to quickly determine “grade-specific” fair market values. This system further allows the user to hyperlink to gathered eBay data as shown in Appendix 3 (at pages A72-A74).

It is to be recognized and understood that the eBay price wizard marketed by the Brazilian firm worldcoinsprices.com is fundamentally flawed with respect to the calculation of average prices for various grades of U.S. coins. Specifically, the Brazilian software enterprise makes no attempt to segregate their calculations by “raw” vs. “encapsulated”, nor does the firm make any attempt to segregate empirical eBay “prices-realized” by grading firm. The present invention attempts to overcome these problems by providing one or more methods for correcting bias associated with empirical prices-realized data.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a block diagram illustrating a remote terminal in contact with a host computer where the host computer is operatively connected to a storage device containing multi-resolution format image data;

FIG. 2 is a block diagram illustrating an embodiment of the present invention in greater detail where multiple remote terminals are in contact with an HTTP computer that is operatively connected with a data storage device containing multi-resolution format image data and a processor that generates HTML pages on-the-fly using this data;

FIG. 3 is a flow chart illustrating the process of an embodiment the invention;

FIG. 4 is a representation of a computer screen display in accordance with an embodiment of the present invention showing a front view and a rear view of a coin and a view of the encapsulated coin (also referred to as obverse, reverse, and holdered views respectively);

FIG. 5 is a representation of a computer screen display in accordance with an embodiment of the present invention showing an enlarged obverse view compared to FIG. 4;

FIG. 6 is a representation of a computer screen display in accordance with an embodiment of the present invention showing an enlarged obverse view compared to FIG. 5;

FIG. 7 is a representation of a computer screen display in accordance with an embodiment of the present invention showing an enlarged obverse view compared to FIG. 6;

FIG. 8 is a representation of a computer screen display in accordance with an embodiment of the present invention showing an enlarged obverse view and an enlarged reverse view compared to FIG. 4;

FIG. 9 is a representation of a computer screen display in accordance with an embodiment of the present invention showing an enlarged obverse view and an enlarged reverse view compared to FIG. 8;

FIG. 10 is a representation of a computer screen display in accordance with an embodiment of the present invention showing an enlarged obverse view and an enlarged reverse view compared to FIG. 9;

FIG. 11 is a representation of a computer screen display in accordance with an alternate embodiment of the present invention showing two sets of viewports for viewing two coins simultaneously;

FIG. 12 is a block diagram illustrating a host computer connected to an electronic auction house computer for transacting business electronically between buyers and sellers; and

FIG. 13 is a front elevation view of a coin case including identifying indicia utilized with an embodiment of the present invention.

FIG. 14 illustrates a plurality of child and subset databases logically gathered from a “parent” database wherein the “parent” database is comprised of online auction data including metadata associated with the exchange of collectible items such as coins, stamps, baseball cards, currency and the like.

FIG. 15A illustrates schematically three unique database pre-processors operating upon a “parent” database for the purpose of correcting bias induced by amalgamating online auction transaction data into a pool without regard for encapsulation, grade or grading firm.

FIG. 15B illustrates schematically a bias corrected resultant database being further operated upon by a series of data analyzers including a coin type index generator, key date and coin type frequency monitor, auction bid log and price analyzer, mathematical price averaging processor, and a statistical analysis processor. Data reporting modules are also illustrated.

FIG. 16 shows a host computer capable of serving relevant peer-to-peer trade data including fair market values and prices-realized data to a plurality of remote computers.

FIG. 17 shows a front elevation view of a “commoditized” encapsulated coin having inscribed upon it a marketing insignia alerting marketplace participants that the encapsulated graded coin is “marketplace-ready”. The illustrated insignia, namely “eBay ready” is exemplary and makes use of the registered trademark “eBay™” owned by EBAY, Inc. of San Jose, Calif. The exemplary “eBay-ready” insignia is presented for the purpose of illustration so that the inventive concepts and teachings of the present invention can be more clearly understood and appreciated using a real world example. The exemplary use of the eBay™ mark in the manner illustrated in the FIG. 17 and as similarly illustrated in other drawings herein should in no way be construed as an endorsement by EBAY, Inc. of the present invention, its commercial applicability or promise.

FIG. 18 shows a data entry method and an illustrative resultant display of a full-text search request wherein the user has keyed a certificate number assigned and associated with a unique encapsulated graded coin using a standard keyboard operatively connected to a personal computer.

FIG. 19 shows a data entry method and an illustrative resultant display of a full-text search request wherein the user has keyed the text string specific to a standard HTTP URL request wherein the URL is assigned and associated with a unique encapsulated graded coin.

FIG. 20 shows a data entry method and an illustrative resultant display of a search request wherein the user has scanned a URL encoded barcode with a standard barcode scanner and the illustrated exemplary barcode being specifically assigned and associated with a unique encapsulated graded coin.

FIG. 21 relates to each of the foregoing drawings FIG. 18, FIG. 19 and FIG. 20 by depicting an enlarged illustrative resultant page showing price-realized trade data specifically associated with an exemplary encapsulated coin being searched. In addition the FIG. 21 shows an exemplary hyperlink for initiating the generation of a trade listing in a streamlined manner.

### DESCRIPTION OF THE PREFERRED EMBODIMENT

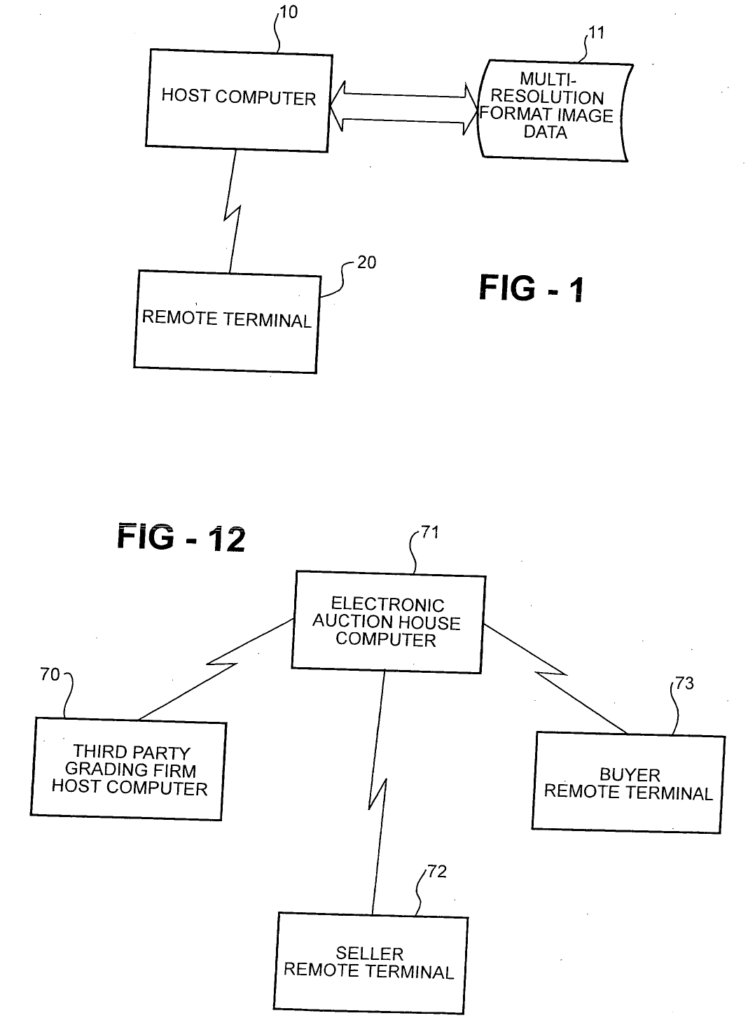

An embodiment of the present invention provides access to linked multiple images of each of a plurality of coins being offered for examination or sale, i.e. a coin image compilation (CIC) for each such coin. When the coin has been certified and encapsulated by an independent third party grading firm, the CIC is known as a Certified Coin Image Compilation (CCIC). It is understood that third party coin grading firms are uniquely positioned within the marketplace, and possess the requisite level of credibility, making them preferred candidates to practice the present invention, but practicing the present invention is in no way limited to third party grading firms. The coin image compilations are provided by a host computer system that is remotely accessible as shown in the FIG. 1. A host computer 10 is operatively connected to a storage device 11. The host computer 10 may be any type of computer as required for a particular level of operation of the invention such as. a personal computer, a network server, a Web server, a microcomputer, a workstation, or a network of such computers. The storage device 11 may be any adequate storage device or multiples of devices such as hard disk drives, CD-ROMs, DVDs, etc.

When a prospective buyer (a user) wants to examine a coin, the user connects a remote terminal 20 to the host computer 10 and accesses the coin image compilation of the coin of interest. The remote terminal 20 may be any suitable device such as a dumb terminal, a notebook computer, a personal computer, etc. having sufficient processing and display capabilities in combination with the host computer 10 to access and view coin image compilations according to the present invention.

The remote terminal 20 can be connected to the host computer 10 via any convenient means, such as through a direct connection, a direct wireless connection, a dial-up connection, a full time network connection, an intranet connection, or an Internet connection, or any variation thereof.

The present invention establishes a virtual coin show that combines elements of all the current sight and sight unseen numismatic markets. As at a traditional coin show, collectors and dealers acting as buyers and sellers can browse available coins that are encapsulated and graded (listed in a database), choose a coin of interest (by clicking their mouse), visually examine the coin in detail (by reviewing the images in the coin image compilation), and conclude the transaction. In addition, like the traditional sight unseen market interested parties don't need to travel to browse coins, and any collector can act as a dealer. Further, the present invention permits comparisons between similar coins, which might not be at the same traditional coin show, and simultaneous comparisons between different views of the same coin.

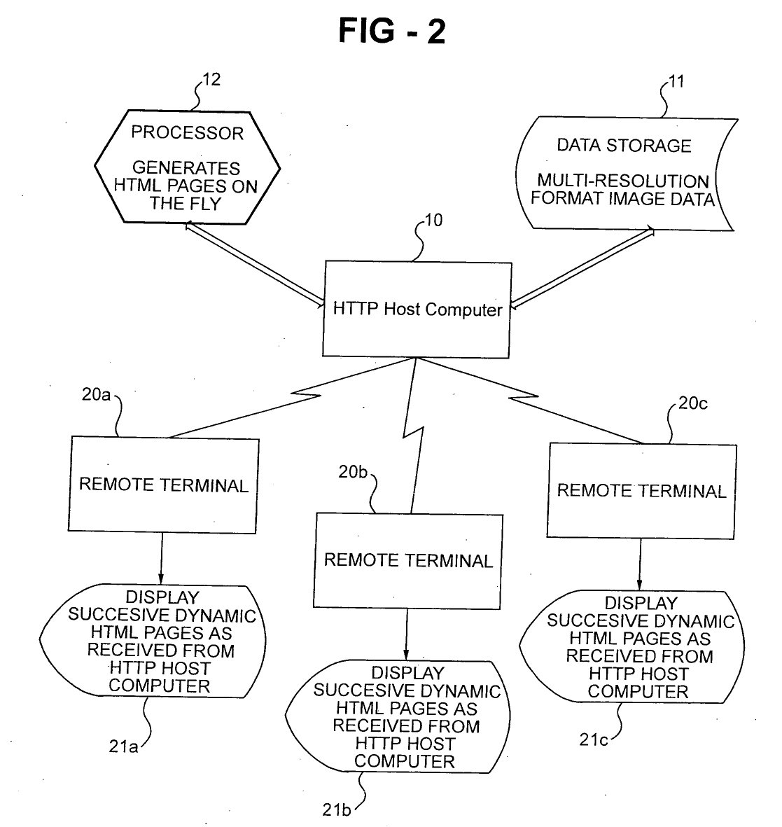

FIG. 2 illustrates the present invention in greater detail where the host computer is operationally connected to the data storage device 11 and a processor 12. In addition, any number of remote terminals as discussed above represented by 20a, 20b, and 20c can be connected to the host computer 10. In this embodiment, the host computer is an HTTP host computer 10. As used herein, an HTTP computer is any Hypertext Transfer Protocol capable computer as described herein.

The data storage device 11 can be any type of data storage device of the type described above. Each coin image compilation stored on the data storage device 11 must include the data required to generate images of various portions of the coin in various degrees of magnification. Typically, the larger the file size, the higher the resolution of an image and more likely that fine image detail will be evident to the user. Storing excessively large graphic image files can be impractical or prohibitive. One solution is to store each desired image as a compressed file, incorporate it within an HTML page and link the pages together to permit “zooming” and “panning”. Such files are typically in GIF format or JPEG format being directly supported by most web browsers. Other graphic file formats although desirable or advantageous may require the downloading of a specific helper application often referred to as Web browser plug-ins. A plug-in provides the Web browser with additional functionality necessary to render a coin image compilation from a file format other than GIF or JPEG. In addition, JAVAScript, JAVA applets, Active X controls and the like may be utilized separately or in combination to provide enhanced Web browser functionality. Each of these image delivery systems can be used with the present invention, but various problems are associated with such systems; e.g., image degradation due to compression losses and slow downloading times.

Another image delivery system suitable for use with the present invention is known as the FlashPix file format by Eastman Kodak Company in collaboration with Hewlett-Packard Company, Live Picture Inc. and Microsoft Corporation. In this format, the original image is stored in the form of multi-resolution image data each containing a plurality of tiled sub-images. The coin image compilation is stored as a set of files in this multi-resolution tiled format for each coin in a database.

Whichever image delivery system is used to implement the present invention, a plurality of images “1” through “N” are linked to provide various views at various degrees of magnification. The “1” through “N” images are arranged to permit a user through a remote terminal to view a coin as the user would if the user held the actual coin. That is in a gross view, as if the coin were held at arm's length, and then in detailed views of every part of the coin, as if different parts of the coins were viewed through loupes of various magnification with particular attention being paid to significant characteristics such as damaged areas, overstrike regions, and mint marks, for example that effect valuation.

The processor 12 of the embodiment illustrated in the FIG. 2 may be a hardware processor, a software processor, or any combination of the two as needed. Preferably, the processor 12 is a processor that is capable of generating Hypertext Markup Language (HTML) pages on-the-fly from the multi-resolution format image data stored on the data storage device 11.

The remote terminals 20a, 20b and 20c represent a plurality of remote terminals connected to the host terminal 10. As discussed above, this connection can be wired, wireless, Intranet, Internet, direct, etc. It is preferred that the connection have sufficient bandwidth to handle the HTML pages generated by the processor at a display rate that is acceptable to the user and to display them on displays 21a, 21b and 21c connected to the respective remote terminals displays 20a, 20b and 20c. It is understood that the method in which the multi-resolution images are passed to the remote terminal for viewing on the display as well as the compression and structure of the compression of these images depends not only on the type of connection, but also on the available bandwidth of the connection. It is also understood that these multi-resolution images may contain textual as well as graphic information corresponding specifically to each encapsulated numismatic item.

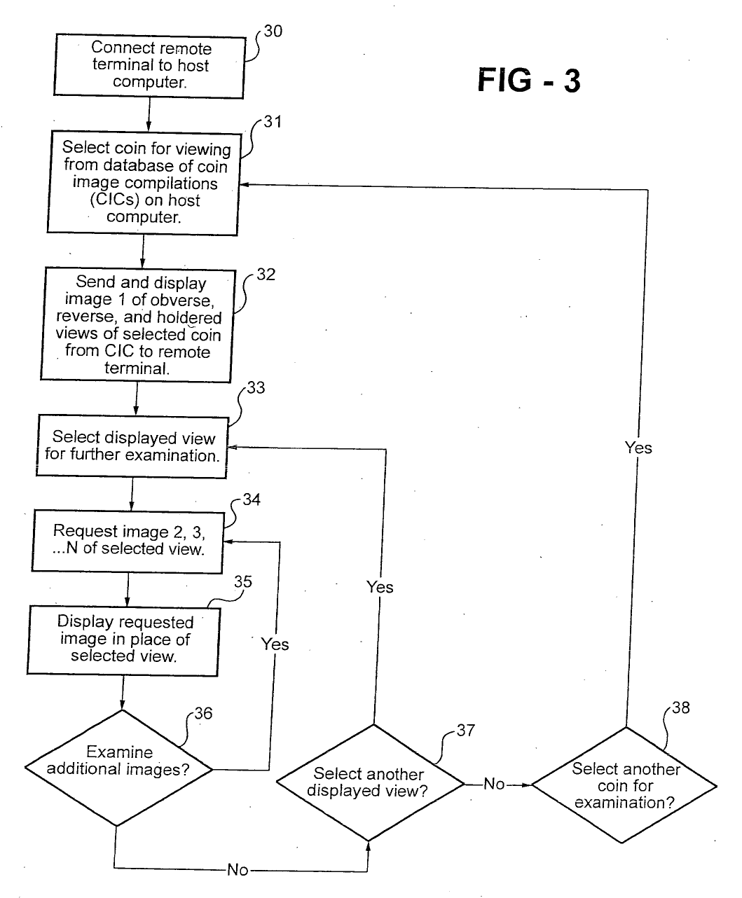

FIG. 3 is a flow diagram of a method according to the present invention for selectively viewing on the remote terminal 20 coin image compilations that are stored on the data storage device 11 connected to the host computer 10. Each of the coin image compilations stored on the data storage device 11 comprises the images “1” through “N” and can include an obverse view, a reverse view, an obverse holdered view, a reverse holdered view and multiple detail views.

The method of the invention begins at a step 30 by connecting the remote terminal 20 to the host computer 10 in any of the possible ways described above. Currently, the most convenient and inexpensive way to accomplish such connection is via the Internet, but the present invention is in no way limited to an Internet connection. A significant contribution of the ingenuity of the present invention resides in the application of identifying indicia to encapsulated coins. By placing written indication on or sealed within protective coin holders such identifying indicia will provide public notice to consumers that the given encapsulated coin has been processed according to the teachings of the present invention. That is to say, the casual observer being in physical proximity to such an encapsulated coin should be able to recognize at a glance that a given encapsulated coin has its respective Certified Coin Image Compilation stored on the firm's host web server and is available for viewing at any time. Identifying indicia can be conceptualized in any number of ways or variations. For example, engraving into the surface of an existing encapsulated coin holder the World Wide Web address (URL) where visual and textual documentation can be located. Similarly, another method may be the application of identifying indicia by etching the URL through a stencil. A less preferred and less permanent method would be through the application of an adhesive label. With respect to coins which have yet to be encapsulated, third party grading and encapsulation firms could simply include such identifying indicia on the existing “certificate” or elsewhere being then safely sealed within the plastic holder. Yet another method available to at least one third party grading firm would be the opportunity to further differentiate CCIC encapsulated coins by using a plastic insert of a different color in combination with any of the aforementioned Web address (URL) identifying indicia variations. Ultimately, this aspect of the present invention is intended to provide a permanent physical indication that a given encapsulated coin has a measure of “added market value” associated with it, namely a Certified Coin Image Compilation residing in “Cyberspace” and accessible via an Internet Web browser. Furthermore, this feature of the present invention provides a direct bridge between the CCIC encapsulated coin and a specific host computer, thereby providing users with a straightforward means of connectivity.

Once a user has connected the remote terminal 20 to the host computer 10, in a next step 31 the user selects a coin for view from a database listing the coin image compilations on the host computer. The database can consist of a list of coins, description, grade, and price, for example and can be similar to an offer list as it appears in coin publications for sight unseen purchases. Such a list may additionally include thumbnails of each of the coins. A hyperlink, for example on the thumbnail may serve as the entry point for a buyer to begin a visual review of the coin image compilation. Typically, selecting the hyperlink is accomplished via a mouse click, but can additionally or alternately include selection via a keyboard command, voice command, etc. If the coin is certified, the selection can be associated with the unique certification number incorporated in the coin holder.

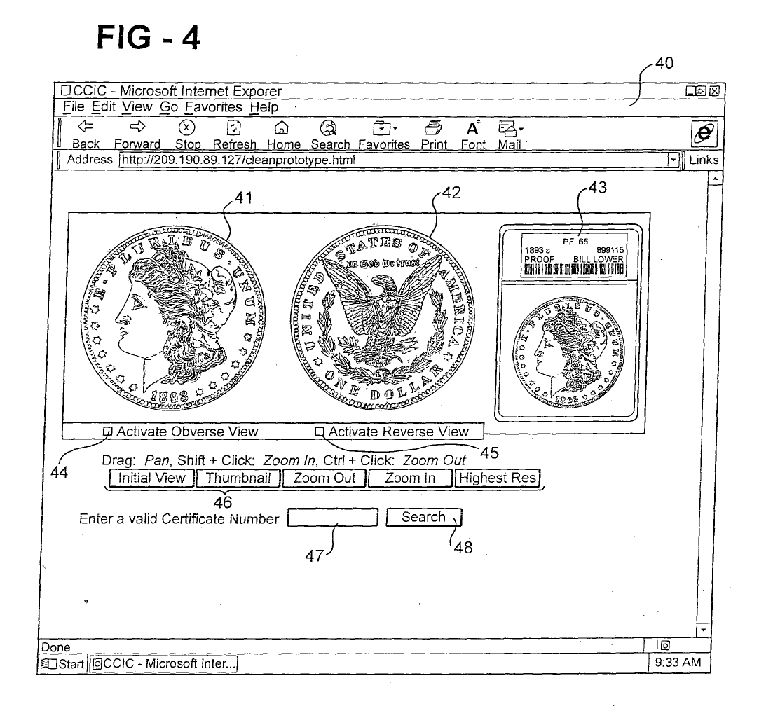

Once the selection signal is sent to the host computer 10, the host computer signals the processor 12 (if necessary) which mediates the transfer of image data from the data storage device 11 in a step 32. The processor 12 could, for example, generate an HTML page on the fly from this data. Preferably, the initial image sent from the host computer 10 to the remote terminal 20 contains a gross overview of the selected coin. Also, it is preferred that the initial HTML page sent from the host computer to the remote terminal for display contain an obverse view, a reverse view, and a holdered view as shown in the FIG. 4.

Having viewed the displayed coin images on the remote terminal 20, a user can select one of the views for further examination in a step 33. Selection, as mentioned above, may be made using a keyboard, mouse click, voice command, etc. or combination thereof. When a user selects a view for further examination, the remote terminal 20 sends a signal to the host computer 10 to request the associated image in a step 34. That is, the remote,terminal 20 sends a signal to the host computer 10 to request the one of the stored images “2” through “N” that is related to the selected view. This image can for example show a portion of the view at greater magnification. While the images “2” through “N” are all related to image “1” in some way, there is no limitation as to which image a user can request for viewing and while it might be most logical to view the images in a sequence such as increasing magnification, the sequence of selecting views for further examination can be completely random, and the user is of course free to return to image “1” at any time. In response to the request from the remote terminal 20, the host computer 10 sends the requested image to the remote terminal, and replaces the selected image with the requested image in a step 35. Alternatively, the requested image could be opened in an additional viewport.

If the user wishes to examine another related image, the method branches at “Yes” in a decision point 36 loop back to the step 34. If the user wishes to select a different displayed view, the method branches at “No” in the decision point 36 and at “Yes” in a decision point 37 to loop back to the step 33. Finally, if the user wishes to select images of a different coin, the method branches at “No” in the decision point 37 and at “Yes” in a decision point 38 to loop back to the step 31.

The FIGS. 4-10 depict a representative HTML page 40 as it would be appear on a display of the remote terminal 20 in the present invention. More specifically, the remote terminal 20 renders the HTML page 40 on a Web browser as an HTML page with each view displayed in an independent viewport 41, 42 and 43. In the FIGS. 4-10, each viewport 41 contains an obverse view, each viewport 42 contains a reverse view, and each viewport 43 contains an obverse holdered view. A reverse holdered view could be provided in another viewport to the right of the viewport 43.

The FIG. 4 shows a gross overview of the entire coin in each viewport. This is the virtual equivalent of how an interested party (referred to herein generically as a “user”) might begin looking at an encapsulated coin at a coin show or dealer's shop. The image in the viewport 43 provides the certification information including the coin denomination, the grade and the certification number.

If the user, having made a cursory examination of the coin, decides to continue examining the coin, any one of the three displayed views can be selected and an additional related image obtained from the host computer (step 33 in the FIG. 3). In the embodiment illustrated in the FIG. 4, additional images are available only for the obverse view 41 and the reverse view 42, with the holstered view 43 presented only for reference. Of course, additional images could be offered for the obverse holdered view, and/or additional viewports could be presented on the HTML page to permit the simultaneous viewing of different images of the same view for comparison purposes.

In the FIG. 4, the user clicks on a check box 44 “Activate Obverse View” or on a check box 45 “Activate Reverse View” to select one of the viewports 41 and 42 respectively. Clicking on an empty check box inserts a “checkmark” to activate the associated function. Clicking on a checked check box deletes the “checkmark” to deactivate the associated function. Selecting a view to examine in greater detail activates a plurality of control buttons 46 for navigating through all the related images that comprise the coin image compilation for the selected view. In FIGS. 4-10, the control buttons 46 are labeled from left to right “Initial View”, “Thumbnail”, “Zoom Out”, “Zoom In”, and “Highest Resolution”. Additionally, appearing above the control buttons 46 are instructions for using the mouse and the keyboard to navigate through related views: “Drag: Pan, Shift+Click: Zoom In, Ctrl+Click: Zoom Out”. These buttons and control combinations are representative and are in no way intended to limit the present invention. The present invention includes any keyboard, mouse, etc. commands that permit a user to navigate through the images of a coin image compilation.

The display 40 shown in the FIG. 4 is selected by entering a certificate number in an information box “Enter a valid Certificate Number” 47 and then actuating an adjacent “Search” button 48. The remote terminal 20 sends the certificate number information to the host computer 10 to search for the associated images in the storage device 11.

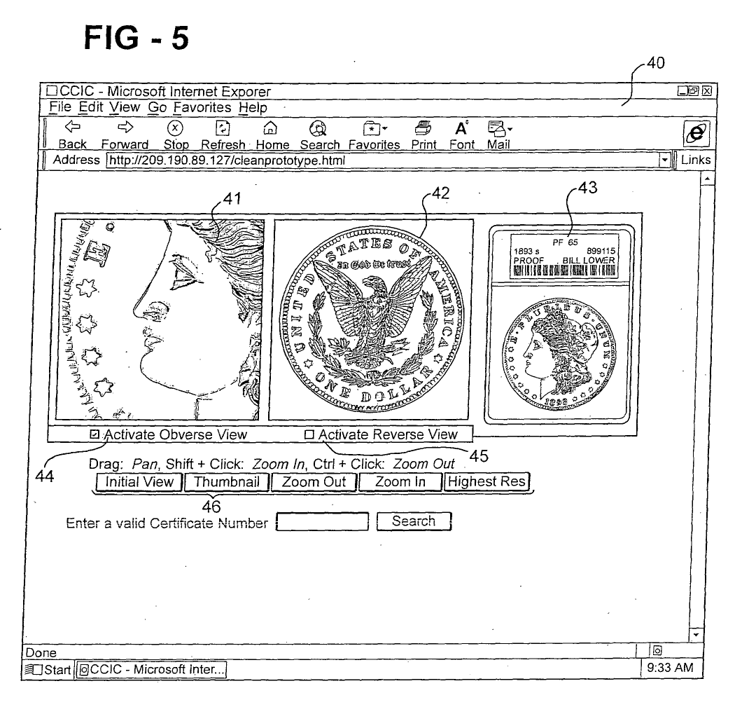

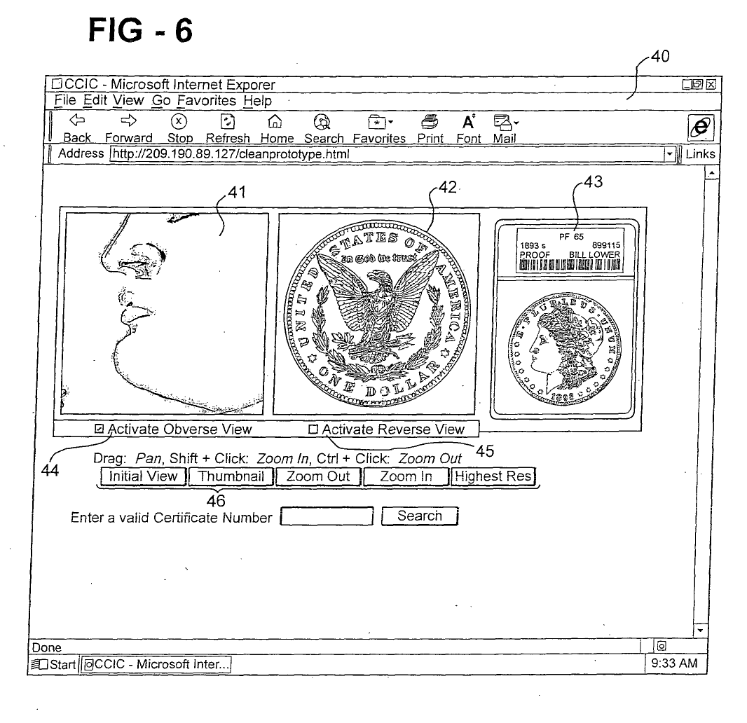

The FIG. 5 illustrates an enlarged portion of the obverse view as displayed in the first viewport 41 on the display of the remote terminal 20. To get this enlarged view, the user selected the “Activate Obverse View” box 44 and one of the control buttons 46 using the mouse/keyboard. In response, the remote terminal 20 formulated a request for an enlarged portion of the Obverse View viewport 41 that was sent to the host computer 10 (step 34 of the FIG. 3). The host computer 10 then located the image requested in the coin image compilation stored on the data storage device 11, and sent it to the first viewport 41 to replace the original image shown in the FIG. 4 per step 35 of the FIG. 3. The steps of repeatedly selecting a view (or both views see, steps 36, 37, 38 of the FIG. 3) to manipulate and manipulating and comparing these views as desired are shown in the FIGS. 6-10.

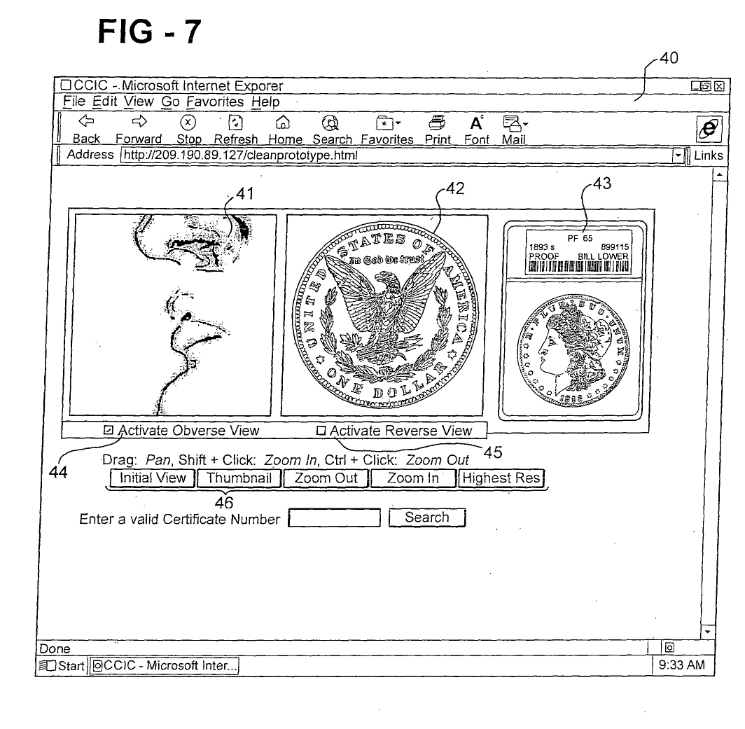

More specifically, the FIG. 6 represents a further step in examining the obverse view. That is, the “Activate Obverse View” box 44 is still checked, and the user has manipulated the mouse/keyboard to “zoom in” further on the Obverse View viewport 41. The FIG. 7 illustrates the results of the user manipulating the mouse/keyboard to “zoom in” still further on the obverse view. While not illustrated, the user may also pan over the surface of the coin in a manner analogous to moving the stage of a microscope under an objective lens to select other portions of the coin for magnification. In the illustrated embodiment, panning the image in the viewport is accomplished by dragging the pointer across the image as instructed above the control buttons 46.

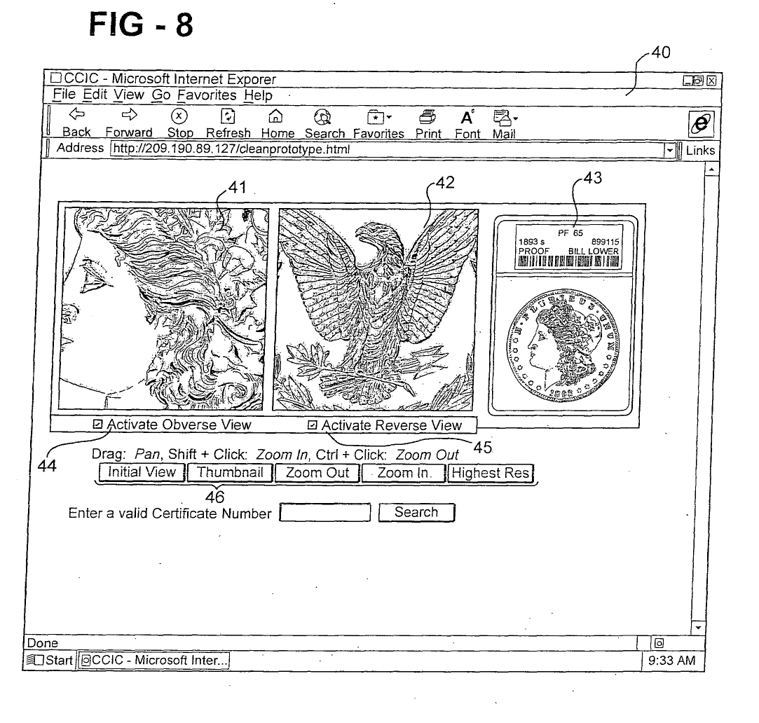

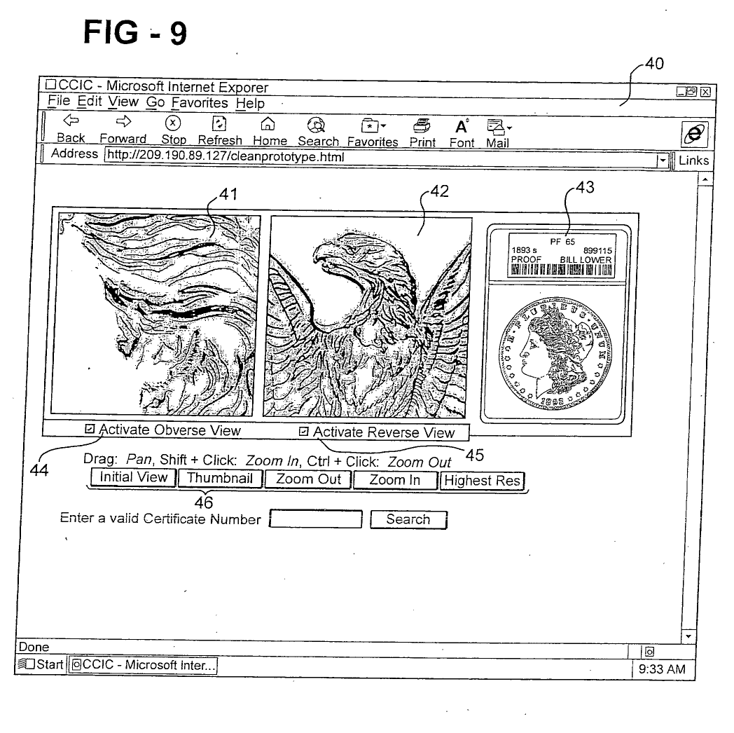

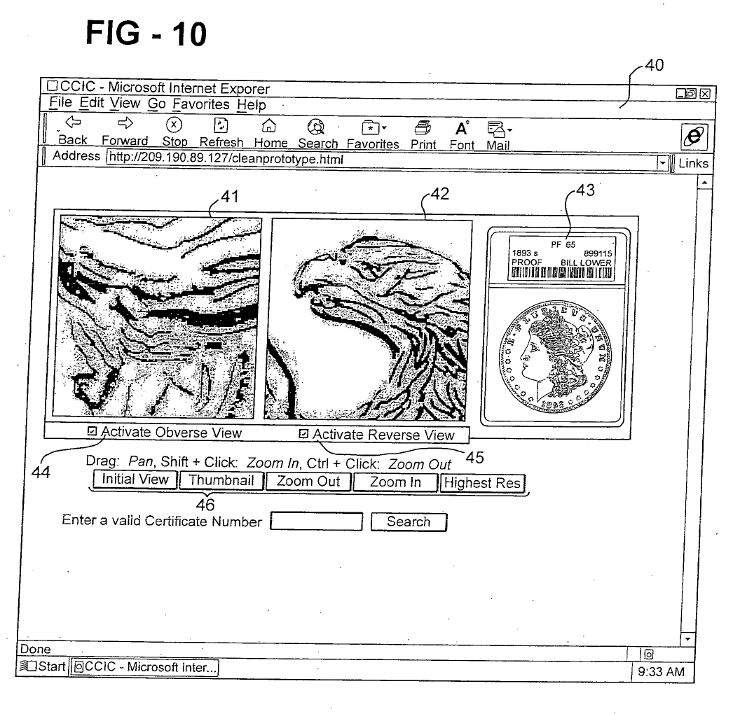

The FIG. 8 illustrates a situation where the user has started to examine the obverse view by selecting the “Activate Obverse View” box 44 and obtaining a first degree of magnification, and then decided to examine the reverse view and selected the “Activate Reverse View” box 45. In this embodiment, when both the “Activate Obverse View” box 44 and the “Activate Reverse View” box 45 are selected, whatever control button the user activates effects both viewports. The FIG. 9 and the FIG. 10 illustrate the effect of the user selecting the “Zoom In” button at least twice: both viewports show images of increased magnification. Such a configuration permits a user to rapidly view both sides of the coin simultaneously.

Just as a user might switch the detail of examination of an actual coin from gross to magnified, obverse to reverse, etc. a user of the embodiment of the present invention is free to change views in any viewport limited only by the number of views that constitute the virtual coin made up by the coin image compilation for that coin. In addition, as mentioned above, a user of the present invention can examine the obverse and reverse views side by side, something that is not physically possible with an actual coin.

The user can view another coin by inserting a certification number in the information box 47 and actuating the “Search” button 48. Thus, if the user wishes to compare the coin just viewed with a similar coin, the host computer 10 will find the newly identified coin image compilation in the data storage device 11, and instruct the processor 12 to formulate the image in an appropriate manner and return it to the remote terminal 20. Depending on the embodiment of the invention, viewports for this second coin could be opened directly below the viewports showing the first coin on the same HTML page, or a second (or third, etc.) browser window could be opened containing a copy of the original HTML with viewports for the second coin. While not illustrated, the information box 47 could also permit the user to loop back to search for other comparison coins of the same type, year, grade, price, etc. by integrating with an appropriately configured search engine.

In a further aspect of the invention, if the remote terminal 20 and the host computer 10 are connected via the Internet, the remote terminal can connect to two (or more) host computers each of which is coupled to a data storage device containing different coin image compilations (or additional images for one coin image compilation as discussed below). This would permit the user to compare similar coins, for example, from two different sources such as different dealers or different grading firms. A situation that is completely analogous with viewing similar coins offered by different dealers at a coin show.

It is understood, that in addition to the graphic information of the images of the coin, a coin image compilation may also contain textual information regarding the coin and that this information may be independently searchable.

In addition to individuals wishing to purchase coins on a virtual active marketplace as described herein, the present invention additionally provides a tool for numismatic researchers, having no direct or immediate interest in selling or purchasing coins, to access a host system in order to closely examine coins for personal education, comparative research, or other academic purposes.

Those skilled in the art of HTML programming and HTTP server configuration will readily recognize and appreciate that a number of variations with respect to HTTP server response are possible. For example, one such method is direct transmittal of “static” HTML pages in response to external requests. Whenever a remote terminal asks to view a particular Web page, the HTTP server is responsible for finding the appropriate HTML file and sending its contents back to the requester. In such instances where the appropriate HTML page is resident (fully encoded and immediately available) no additional processing by the server is required. A single coin image compilation can be made up of a number of hyperlinked HTML pages configured so that selecting the “Zoom In” button as illustrated in the FIGS. 4-10 calls the HTML page containing a zoomed image.

In addition, the present invention can use server configuration methods that transmit HTML encoded pages dynamically. Rather than devoting a significant portion of storage media to archive “static” HTML pages, this method permits HTML pages to be generated by the system as needed in response to external requests. Such “on-the-fly,” dynamically generated HTML page delivery preferably is based on web-database connectivity software programming techniques. For example, a simple database (.dbf) file or Microsoft Access file can be configured to contain thousands of records, each of which corresponds to a unique coin. A remote user to the Web site of a third party grading firm could enter a certificate number into the box 47 (as illustrated in the FIG. 4) or other identifying or searchable characteristics and press a submit button to transmit this information to the grading firm's HTTP server. Unlike “static” HTML pages, in which the server would handle the request directly, the HTTP server of this embodiment would parse the string containing the certificate number. The parsed string would then be passed as a parameter to a separate CGI (Common Gateway Interface) program or server side API (Application Programming Interface) for processing (illustrated generically as a processor 12 in the FIG. 2). The server side API or CGI program would then write an HTML file on-the-fly, incorporating the appropriate image tags and return control to the HTTP host computer or server 10. The HTTP host computer 10 would then send the contents of the dynamically generated HTML file to the user's browser mounted on the remote terminal 20, and the browser would render the appropriate visual display exactly as if the transmitted file had resided on the server as a “static” Web page.

Presenting coalesced information simultaneously as if all the content of one Web document originated from a single source (host) is a powerful technical feature of the World Wide Web. Likewise, the linking capability inherent within Hypertext Markup Language (HTML) dramatically increases the utility of the World Wide Web by providing nonlinear links to various screen elements such as text, images, sound bites, video clips, etc. It should therefore be readily evident to Web site authors and HTML programmers that the display of information on the World Wide Web relating to numismatic items can result from distributed content being simultaneously provided from more than one host computer. Thus, it is preferred that the present invention be configured for use on the World Wide Web, or an Intranet equivalent thereof.

When the present invention is in use via the World Wide Web, not only is it possible for a user to access multiple host computers to view coin image compilations for different coins, it is also possible for a single coin image compilation to be located on different host computers connected to the World Wide Web. This is particularly convenient, for example, when a collector wishes to act as a dealer by putting a coin in his possession on the market. For example, if a coin collector initiates a public auction via an established third party Internet auction service such as eBay™ (www.eBay.com), the collector (or eBay™) can easily embed within the description of the coin, standard HTML reference tags that point to image files stored on a computer or computers other than those controlled by eBay™.

At present, a major problem with HTML files that contain embedded graphic files such as “.GIF” or “.JPG” files is that such graphic files can require a discernible period of time to pass from a host computer to a remote terminal using commonly employed modems with speeds up to 56K. This amounts to a significant delay that is unsatisfactory.

One method incorporated in the present invention for mitigating this delay is the incorporation of specific program applications (applets) directly from the host computer (Web server) to the remoter terminal (Web browser). Program applications written in the JAVA programming language (JAVA applets) are particularly useful because they run on many types of remote terminals without modification. For example, platform independent JAVA applets can run on both Netscape Communicator and Internet Explorer browsers. Applets execute more elegantly than plug-ins, download quickly, and don't require user intervention.

The present application specifically incorporates the use of at least one program application, such as a JAVA applet or an ActiveX control with each HTML page loaded from the host computer to the remote terminal. Another embodiment of the present invention incorporates a program application such as a JAVA applet or ActiveX control with each viewport.

An additional embodiment of the present invention stores each multi-resolution coin image compilation in a hierarchical, tiled, digital image file format, such as the FlashPix image file format identified above that stores images stored in a hierarchical, tiled, digital format. A format such as FlashPix takes up slightly more storage space (memory), than an image source file such as a TIF file generated by a high-resolution digital camera. The overall size of an FPX file format file is approximately 33% larger than a comparable flat file because the entire resolution pyramid is stored in the image server. Nevertheless, users can quickly preview the entire image at low resolution, zoom in on a portion of an image at a progressively higher resolutions for monitor display, and then download either the zoomed-in portion or the entire image at even higher resolution for photographic-quality printing. This flexibility greatly speeds the time it takes to view and print high-quality images over the Internet, where bandwidth is very limited compared to high-speed networks. FlashPix, therefore, is preferred for use with embodiments of the present invention.

More specifically, FlashPix images are tiled, multi-resolution format images where each image is available in multiple resolutions, each twice as large as the previous level. Each resolution level is divided into square tiles of sub-images of 64×64 pixels. Each tile in the image is independently accessible, so an application can display a viewport of any part of an image without having to load the entire image into memory. The lowest resolution of an image is always level “0”, which always fits within a single FlashPix image tile. The present invention can be configured so that level “0” is a thumbnail identifier or the most gross image initially displayed in the HTML page viewport as described above. Further, the FlashPix format permits image elements to be stored by reference so components of a coin image compilation stored in the FlashPix format permits more detailed views to be stored at different locations rather than requiring that they be stored directly within the same coin image compilation file.

It is preferred, that the images making up a coin image compilation be capable of being stored by reference. This permits, for example, the host computer to store gross obverse, reverse, and holdered views in memory while more detailed views are stored on a storage device such as a CD-ROM or DVD disk.

Even with TI lines, cable modems, and satellite modems becoming more popular, the use of applets and/or the use of multi-resolution coin image compilations stored in a hierarchical, tiled, digital image file format are still preferred in order to permit the movement of maximum amounts of data in the minimum amount of time.

In the present invention, it is preferred that a JAVA applet be associated with each viewport to handle accessing and display of hierarchical, tiled, digital image file format images.

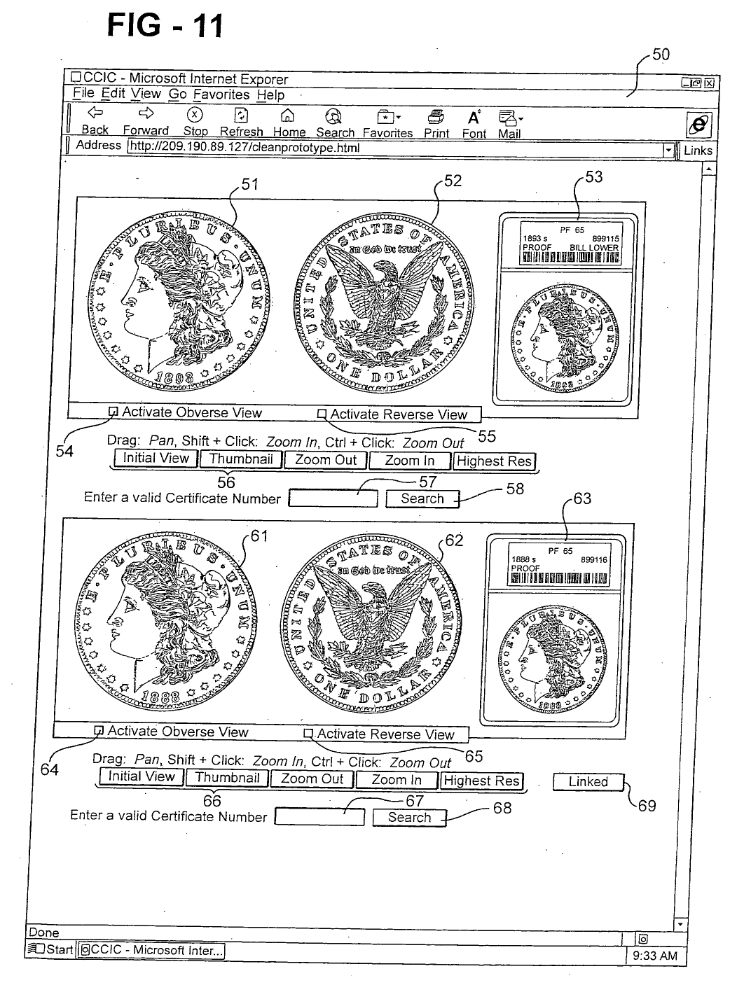

The FIG. 11 depicts a representative HTML page 50 similar to the page 40 in the FIG. 4 wherein the reference numerals 51 through 58 correspond to the reference numerals 41 through 48 respectively. However, a second set of viewports 61, 62 and 63 are positioned below the viewports 41, 42 and 43 respectively to provide a means for comparing two coins utilizing corresponding views. A check box 64 “Activate Obverse View”, a check box 65 “Activate Reverse View”, a plurality of control buttons 66 for navigating through all the related images that comprise the coin image compilation for the selected view, an information box “Enter a valid Certificate Number” 67 and an adjacent “Search” button 68 provide functions similar to those described in connection with the reference numerals 44 through 48. Each of the viewports can be controlled individually, or a “Linked” button 69 can be provided to cause, for example, the check boxes 54 and 55 and the control buttons 56 to control both sets of viewports so that corresponding portions of the two coins are viewed simultaneously at the same magnification.

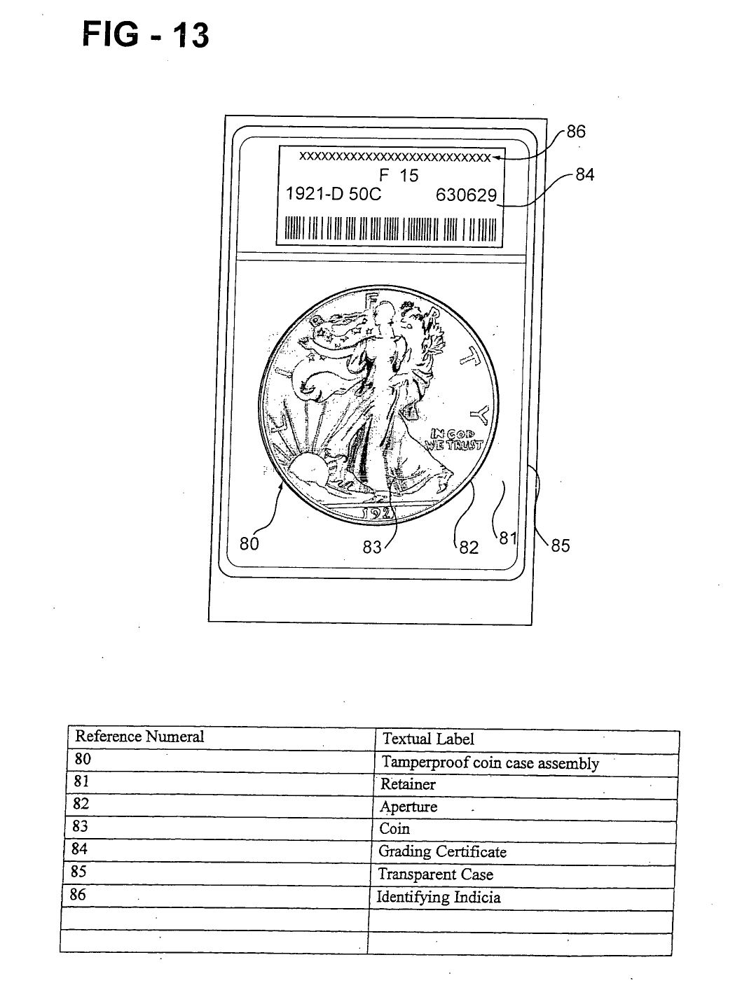

The FIG. 12 is a block diagram of the present invention configured to facilitate the sight-unseen trading of objects such as exonumia between a first party (a seller) and a second party (a buyer). A third party grading firm maintains a host computer 70 similar to the host computer 10 described above. The computer 70 includes the data storage device 11 and the processor 12 for generating HTML pages of the CCIC's representing coins that have been graded by the firm. The host computer 70 can be connected to a marketplace computer such as an electronic auction house computer 71 maintained by a fourth party to the transaction. The seller can use a seller remote terminal 72 to connect to the auction house computer 71 to list for sale a coin owned by the seller. If the coin was graded by the third party grading firm, the corresponding CCIC is stored in the computer 70. The auction house can list a description of the coin on a web page and link the description to the corresponding CCIC. The buyer then connects a remote terminal 73 to the auction house computer 71 and locates the coin offered for sale. The buyer can view the CCIC for the coin that is available from the host computer 70 through the auction house computer 71. In this manner, the buyer can inspect the coin utilizing images that were generated and maintained by the trusted third party grading firm.

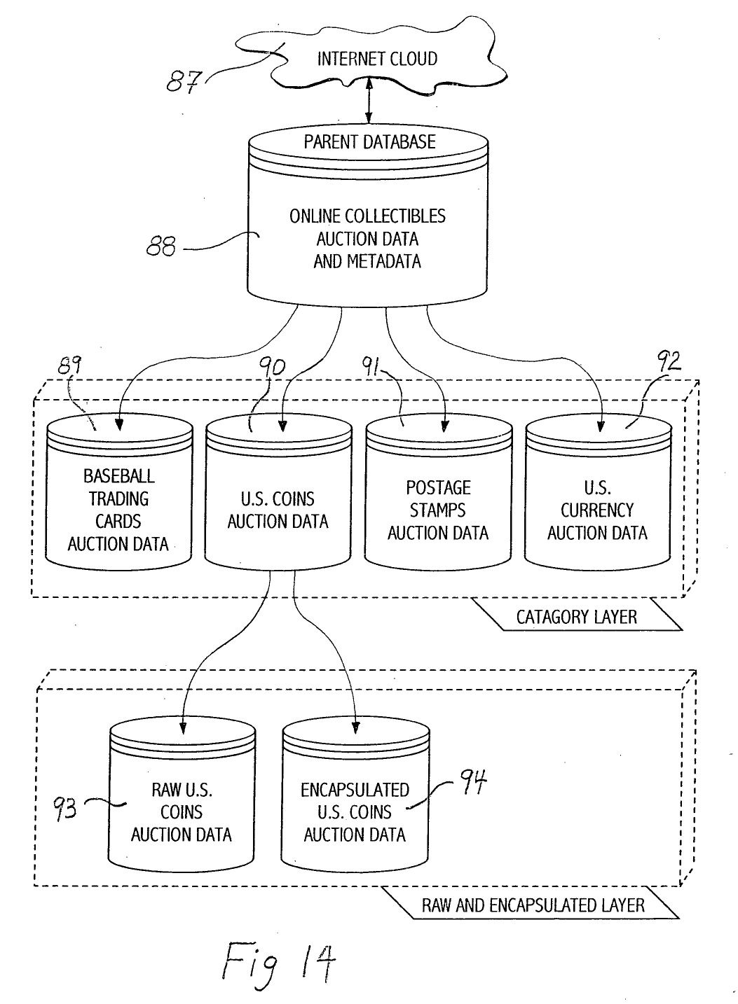

There is shown in the FIG. 13 a typical tamper-evident (formerly “tamperproof”) coin case assembly 80 utilized by third party grading firms. The assembly 80 includes a generally planar coin retainer 81 having an aperture 82 formed through it for retaining a coin 83 such that both sides of the coin are completely visible. A generally planar grading certificate 84 is prepared by the third party grading firm to provide information about the coin 83 such as a grade “F 15”, a year and mint “1921-D”, a denomination “50C” and a unique certificate number “630629”. The retainer 81, the coin 83 and the certificate 84 are then encapsulated in a holder such as a transparent case 85. The assembly 80 can be traded from seller to buyer with a high degree of confidence in the grade of the coin 83.

The certificate number can either be replaced by or supplemented by a unique identifying indicia 86 that permits locating the associated CCIC and viewing images of the coin 83. During the grading process, the necessary images of the coin 83 are created and stored in the host computer 70 (FIG. 12). The CCIC can be accessed by utilizing an identifying indicia 86 that is a URL. For example, the identifying indicia http://www.tpgs.com/ccic/123456.html (where “tpgs.com” is the third party grading firm web site) affixed to the assembly 80 permits the seller to identify the CCIC to the auction house which can link to the CCIC in the host computer for viewing by the buyer. The identifying indicia 86 can be applied to: the retainer 81, the grading certificate 84, the interior of the case 85 before encapsulation, or the exterior of the case 85 after encapsulation by any suitable method such as printing or engraving. The identifying indicia 86 can serve as both the certificate number and the database locator whether or not the coin has a certificate number associated with it. All of this information can be reproduced in bar code form as shown in FIG. 13 for reading by automatic scanning equipment.

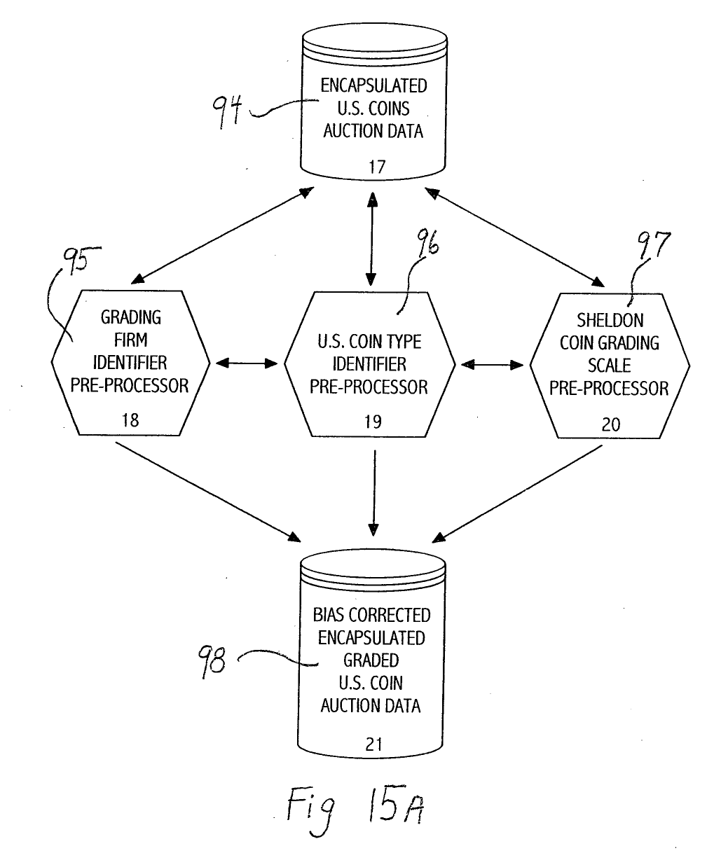

The FIG. 14 illustrates an exemplary embodiment of the present invention wherein various subset databases comprised of online auction information are gathered according to the present teachings. A parent database 88 comprised of online “collectibles” auction data including metadata may be gathered for example from one or more online auction facilities (Web sites) such as eBay.com, yahoo.com and amazon.com to name a few. Accordingly, the FIG. 14 shows that the parent database 88 is gathered from the global computer network illustrated as an Internet cloud 87. The exemplary parent database 88 comprised of Internet online “collectibles” auction data may be gathered manually. Alternatively, other embodiments may employ data mining methods for gathering “collectibles” auction information. For example, a computer program which directly accesses an auction facility's databases (e.g. XML application) or alternatively, a special purpose Internet scanning agent such as Offline Commander distributed by Zylox, Inc., may be used to persistently gather the relevant data from one or more Internet Web sites or online auction facilities. Software applications or other equivalent data mining methods such as these may be used separately or in conjunction with one another. Alternatively, an auction facility may provide a parent database or may generate any number of subset databases relating to its online peer-to-peer trade listings and may provide them directly to one or more interested third parties. In practice, online auction Web sites (“trusted” peer-to-peer trading environments) commonly present auction data including metadata in real-time to buyers and sellers that participate in an auction in order to better enable participants to monitor the fair workings of the auction. With respect to “prices-realized” data, online auction facilities offering auction-style listings often provide participants with open-access to individual bid logs or bid histories. The present invention includes all systems, methods or means by which a parent database is gathered or acquired irrespective of whether the acquisition is accomplished manually, automatically or by direct provisioning. The illustrated exemplary parent database 88 includes data and metadata associated with a plurality of online auction-style listings for collectible coins, sports trading cards, stamps, currency and the like. Preferably, such data includes individual bid logs or individual bid histories associated with each completed transaction (auction listing).

In a block marked Category Layer, the FIG. 14 further illustrates the gathering of exemplary “child” databases of auction data such as for major league baseball trading cards 89, U.S. coins 90, postage stamps 91, and U.S. currency 92. For purposes of illustration but not limitation, the exemplary “child” databases 89, 90, 91, and 92 are representative of categories recognizable within the content format of a peer-to-peer trading environment, online auction facility or similarly configured Web site such as eBay™ for example.

In an additional block marked Raw & Encapsulated Layer, the FIG. 14 further illustrates two subset databases separated from the exemplary “child” U.S. coins database 90, wherein one subset database represents online auction data associated with “raw” U.S. coins 93 and the other subset database represents online auction data associated with graded and certified “encapsulated” U.S. coins 94. It is to be understood that segregation based on “raw” vs. “encapsulated” graded objects is heretofore unknown and absent within the recognizable categorization schema employed by online auction facilities such as eBay™, for example. Likewise, segregation based on grading firm identification is also heretofore unknown and absent within the recognizable categorization schema employed by online peer-to-peer trading facilities such as eBay™, for example. Although not illustrated, additional subset databases could also exist, being similarly gathered for major league baseball trading cards 89, postage stamps 91, and U.S. currency 92 and these may also be segregated further into “raw” vs. encapsulated “collectible” items. It is to be understood that the parent database 88 is exemplary and those skilled in the art will recognize and appreciate that any appropriately gathered “child” or subset database may serve adequately as a primary information source (“parent” database) pursuant to the practice of the present invention.

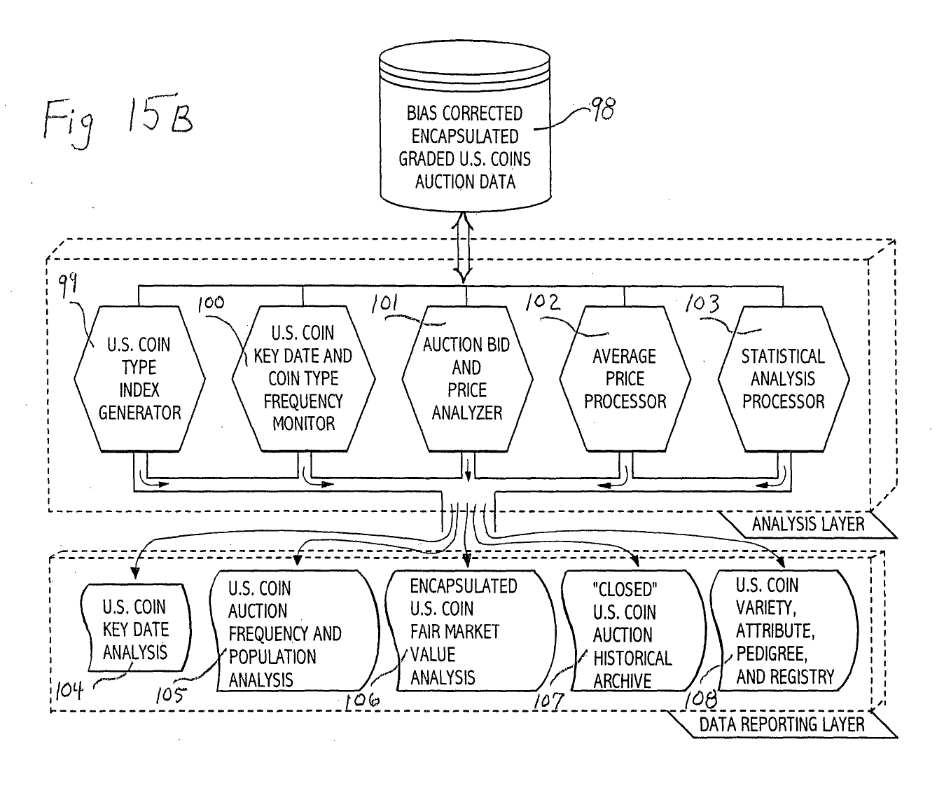

In one embodiment of the present invention, FIG. 15A illustrates schematically exemplary components of the present invention wherein the “subset” database 94 comprised of “encapsulated” graded certified U.S. coins is operated upon by a series of pre-processors in order to correct data bias. It is well known in the art that grading standards may differ significantly from grading firm to grading firm. It would therefore be erroneous and undesirable to treat like graded coins as fungible without first recognizing and analyzing how differences in grading standards impact the range of “prices realized” for like coins trading in the numismatic marketplace. The exemplary pre-processors 95, 96 and 97 illustrated in the FIG. 15A are deemed useful in order to remove bias induced by amalgamating online auction transaction data into a pool without regard for encapsulation, grade or grading firm.

It is to be understood that the implementation of any pre-processor to correct bias as herein illustrated in the FIG. 15A could be circumvented by first capturing the relevant encapsulation indicator, grading firm identity, and assigned grade data at its source (i.e. an auction facility) and storing such relevant data in a predetermined manner allowing the data pool to be organized more efficiently. Once all relevant data is stored and organized in the aforementioned circumventing manner, the database 94 can be sorted (segregated) as to raw, encapsulated, assigned grade and applicable grading firm. For example, if an auction facility (e.g. eBay™) were to provide such a means during the auction initiation process wherein data provided by the seller (or trusted third party) is gathered, the amalgamated pool of data 88 in the FIG. 14 could be more readily segregated as to raw, encapsulated, assigned grade and grading firm. The steps of a method wherein an auction facility (e.g. eBay™) purposefully captures or otherwise stores a raw or encapsulated indicator, a grade indicator and/or an applicable grading firm identity shall each constitute an embodiment of the present invention. Correspondingly, it will recognized and appreciated by those skilled in the art that an independent auction listing tool, a third party data repository or alternative third party Web site may enable a user (seller) to generate an online auction instance (auction-style listing) on behalf of the auction facility (e.g. eBay™) and in doing so, the means for gathering the at least relevant grade indicator and applicable grading firm identity would be implemented in an equivalent circumventing manner as suggested by the present teachings. It is to be understood that such independent auction listing tools and/or third party Web sites as disclosed herein are heretofore unknown in the art. Therefore, the practice of gathering the at least relevant raw indicator, encapsulated indicator, grade indicator and/or applicable grading firm identity utilizing an independent auction listing tool, third party data repository or third party auction enabling Web site shall constitute alternative embodiments of the present invention. As a practical consideration, third party grading firms could provide the marketplace with graded encapsulated objects that are conspicuously marked “marketplace-ready”, “auction-ready” or “eBay™-marketplace-ready” or any meaningful variation thereof, for example. Accordingly, graded encapsulated objects being conspicuously marked or inscribed in such a manner may be exchanged in the marketplace utilizing auction facilities (e.g. eBay™) willing to receive the aforementioned at least “relevant trade data” already assigned and associated with each unique graded encapsulated object. Additional metadata (e.g. high resolution images, etc.) may also be included or otherwise made available in a predetermined manner. Streamlining the operation of online auction Web sites and facilitating the exchange of encapsulated graded objects in this way improves transactional efficiency within the marketplace and is therefore preferred. Accordingly, graded encapsulated objects possessing already assigned and associated characteristics including relevant trade data thereby making such objects “marketplace-read”. shall constitute an alternative embodiment of the present invention. Using the present inventor's own lexicon, this present teaching shall be defined as “commoditizing” graded encapsulated objects thereby facilitating the exchange of such objects. Commoditizing graded encapsulated objects provides the marketplace with a highly efficient streamlined trading means.

In the FIG. 15A a grading firm identifier pre-processor 95 is employed to identify and maintain the grading firm association with each of the encapsulated coins comprising the “subset” database of “encapsulated” graded certified U.S. coins 94. In a prior, subsequent or concurrent process, a U.S. coin type identifier pre-processor 96 operates upon the exemplary illustrated “subset” database 94 for the purpose of assigning a coin type key expression to each encapsulated coin record. In this way, once a coin type key expression is established for each database record, the resultant encapsulated graded U.S. coin database 98 will be comprised of a plurality of unique records wherein the resultant database may be organized by U.S. coin type. This is especially important when in a subsequent process the fair market value for like encapsulated coins sharing common characteristics such as date, mintmark, grade and grading firm is to be analyzed. Correspondingly, a database key expression such as the aforementioned coin type identifier may have utility with respect to the generation of coin census reports indicating populations “sold” as well as presenting “type-specific” frequency distributions.

In a prior, subsequent or concurrent process, a coin grading scale pre-processor 97 operates upon the exemplary illustrated “subset” database 94. The illustrated Sheldon coin grading scale pre-processor 97 maintains and preserves the grade association for each encapsulated coin. This is especially important when in a subsequent process the fair market value for like encapsulated coins sharing common characteristics such as date, denomination, mintmark, grade and/or grading firm is to be determined.

The resultant database 98 is uniquely configured so as to provide bias corrected data including bias corrected metadata associated with each encapsulated coin having been successfully pre-processed according to the present teachings. Database records associated with the exemplary illustrated “subset” database 94 which for any reason are unable to be successfully pre-processed by any or all of the illustrated exemplary pre-processors 95, 96, 97 are set aside for further review or may be excluded altogether. The illustrated exemplary pre-processors 95, 96, 97 may be software based, hardware based or any combination of software and hardware necessary for the successful processing of relevant data.

A significant contribution of the ingenuity of the present invention resides in the application of one or more database pre-processors for the purpose of correcting the data by removing or otherwise mitigating the unwanted effect of bias. Regarding the FIG. 14 it is to be further understood that data pools (“parent databases”) containing a combination of both “raw” and encapsulated graded objects are inherently bias and therefore it is preferred that a database pre-processor (not illustrated) serving to segregate “raw” objects from encapsulated objects be employed. Of course, as mentioned above, such a pre-processor would not be required if the peer-to-peer trade facility (e.g. eBay™) captured or otherwise stored a raw indicator or an encapsulated indicator during the initiation of an appropriately configured trade listing wherein data provided by a seller is first gathered. Alternatively, the existence of an encapsulation indicator may be computed or otherwise derived by logical deduction. For example, if it is known that an object is graded by PCGS, for example; that is to say, if PCGS is the known grading firm identity for the object, then an indicator of encapsulation is derivable.

In the FIG. 15B the resultant database 98 containing bias corrected encapsulated graded U.S. coins auction data is operated upon by a series of processors in order to further refine the relevant bias corrected auction data. In a block marked Analysis Layer, the FIG. 15B illustrates the logical application of generators, monitors, analyzers and processors each having one or more specific purposes relevant to the present teachings. In the FIG. 15b an exemplary U.S. coin type index generator 99 analyzes relevant bias corrected auction data for encapsulated U.S. coins 98 and provides various database indices (database views). Such database indices may be virtual or redundant or any known equivalent thereof with respect to the parent data source or sources. For example, a chronological view (database index) may be generated thereby providing a “mint date” ordered index or database view. Alternatively, an index may be generated to provide a view of the relevant price or high bid data wherein such data is organized in descending order based solely on price-realized data. For example, the most expensive coin ever sold at auction would logically appear as the first record within such an index. Correspondingly, the end of file (last record) would logically represent the most inexpensive price realized for an encapsulated graded U.S. coin sold via an online trade listing. The number of unique indices or database views to be generated by the exemplary U.S. coin type index generator 99 is limited only by the number of combinations and permutations associated with the underlying database structure of the resultant database 98.

In the FIG. 15B the resultant database 98 containing bias corrected graded encapsulated coin auction data may be operated upon by a U.S. coin key date and coin type frequency monitor 100 wherein the illustrated exemplary monitor rank orders all relevant transactions with respect to frequency. Of special interest is the ongoing monitoring of key date U.S. graded encapsulated coins. Sophisticated probability analyses may be initiated to test the hypothesis that the next chronologically occurring trade listing would involve a key date U.S. coin for example. Correspondingly, sophisticated probability analyses may be initiated to test the hypothesis that the next chronologically occurring trade listing would involve the most common (most frequently re-occurring) U.S encapsulated coin, for example. A system for calculating and tracking the probability of exchange for individual encapsulated graded objects is heretofore unknown in the art.

In the FIG. 15B the resultant database 98 containing bias corrected encapsulated graded coin auction data may be operated upon by a historical U.S. coin auction bid and price analyzer 101. It is to be understood that peer-to-peer trading using auction-style methods can induce bias especially where reserve price and so-called “buy-it-now” practices are encouraged or otherwise allowed. The historical U.S. coin auction bid and price analyzer 101 may be employed to analyze successful trades wherein only a single bid was offered or wherein the spread between a “buy-it-now” offer and the winning bid is significant. Similarly, where only two bidders compete for a given encapsulated coin, bidding may become unreasonably aggressive brought on by competitive emotions rather than by true demand. This aspect of the present invention can offer analyses that are quite complex or alternatively, quite simple.

In the FIG. 15B the resultant database 98 containing bias corrected encapsulated graded coin auction data may be operated upon by a mathematical average price processor 102. The purpose of such a processor is to determine the average selling price for one or more encapsulated coins using empirical data. The price processor 102 operates on resultant database 98 and isolates from the auction data the winning bid for each unique encapsulated coin auction record. In a further step and when applicable, a fair market value is established for like encapsulated coins sharing common characteristics such as date, denomination, mintmark, coin type, grade and/or grading firm. The fair market values are to be determined by a procedure that employs standard mathematical averaging or variations thereof. It is well known in the mathematical and statistical arts that averaging by standard mathematical means is an inherently biased procedure and care should always be taken with respect to statistical inference. Therefore, a statistical analysis processor 103 may be used to determine (among other things) the probability that the calculated mean (i.e. calculated average price-realized) is the true mean of a distribution.

Statistical inference is the process of analyzing data from a sample population in order to answer a specific question or in order to test a hypothesis. With respect to the present invention, statistical analysis may be used to test the hypothesis that the calculated mean of a population sample is the true mean. For each graded encapsulated object in the sample, the measure of the numerical characteristic (i.e. average price- realized) of interest is denoted as X. Sample: (X₁, X₂, X₃, . . . , Xₙ)

Compute the sample mean

$$\overline{X} = \frac{\sum {x}_{i}}{n}$$

and sample standard deviation

$$S = \sqrt{\frac{\sum {x}_{i}^{2} - {( \sum {x}_{i} )}^{2} / n}{n - 1}}$$

The sample mean \overline{X} is a point estimate of the unknown population mean. Different random samples of size “n” from the same population will result in different sample means, giving different estimates. The distribution of means from all possible random samples of size “n” is the sampling distribution of \overline{X}.

The mean of all possible sample means is “m”. Therefore, \overline{X} is an unbiased estimator of “m”.

The standard deviation of the sampling distribution of X is

$${σ}_{\overline{x}} = \frac{σ}{\sqrt{n}}$$

The block marked Analysis Layer, in the FIG. 15B, illustrates the logical application of generators, monitors, analyzers and processors each having one or more specific purposes relevant to the present teachings. Each illustrated generator, monitor, analyzer and processor represent independent means that can be used alone or in conjunction with one another to provide low-cost and expeditious analysis in comparison to conventional methods. The illustrated price processor 102 and the statistical analysis processor 103 (used separately or collectively) provide a means for estimating marketplace demand for graded encapsulated objects.

In some embodiments, the results of the illustrated generators, monitors, analyzers and processors may be implemented in an on-line auction Web site (e.g. eBay™) as a service to buyers and sellers who participate in auctions on the Web site. Sellers acting as independent auction listing originators and bidders may benefit from the demand estimate information developed by the illustrated generators, monitors, analyzers and processors. Disseminating information that aids in the formulation of realistic price expectations is desirable and will likely benefit all market participants. Potential buyers welcome information sources that help them determine initial starting bids and bidding strategies.

In a block marked Data Reporting Layer, the FIG. 15B illustrates the logical application of various documentation modules that may be generated from the bias corrected encapsulated graded U.S. coins auction data 98. As mentioned above, key date U.S. coins are of special interest to market participants. Therefore it can be anticipated that marketplace participants would desire documentation that analyzes marketplace factors pertaining to key date U.S. coins including the reporting of fair market values. A key date analysis for U.S. coins 104 is shown in the FIG. 15B and may be implemented in any number of ways including online HTML presentation via an appropriately configured Web site. Alternatively, documentation relating to key date U.S. coins 104 may be provided to marketplace participants via printed media such as books, magazines, newsprint, etc.

In the FIG. 15B there is also illustrated a U.S. coin auction frequency and population analysis 105. Population census reports for encapsulated graded objects are well known in the art. It is not unusual for rare and highly collectible coins to be held for extended periods of time. Investment level U.S. coins are generally quite scarce and their respective populations as reported by the third-party grading firms reflect the known or anticipated scarcity. It is to be understood and recognized that the frequency of exchange with respect to scarce investment quality coins is not easily reported in the art. Accordingly, in the FIG. 15B there is illustrated a data reporting module that may be generated from the bias corrected encapsulated graded U.S. coins auction data 98 wherein the frequency of exchange associated with individual U.S. coins may be reported. A logical comparison between known population census figures and the rate of exchange constitutes an embodiment of the present invention.

In the FIG. 15B there is also illustrated a data reporting module pertaining to encapsulated U.S. coin fair market value analysis 106. Such documentation can be reported in any number of ways or variations. For example, the results of average price calculations may be reported as a singular data point for each encapsulated graded coin being reported. Alternatively, a moving average can be tracked and documented over time. In this way market trends can be presented and if appropriately extrapolated, a fair market value forecast may also be presented. This data may be reported in tabular form and/or illustrated as a graph. Another possible variation may be the reporting of a fair market value “range” as opposed to a singular data point. The statistical analysis processor 103 may be used to construct a 95% confidence interval for each reported fair market value. The reporting of peer-to-peer trade data including fair market values may therefore be implemented in any number of ways including online HTML presentation via an appropriately configured Web site. Alternatively, documentation relating to peer-to-peer trade data and fair market values for U.S. coins 106 originating from the practice of one or more embodiments of the present invention may be provided to marketplace participants via offline means such as printed books, newsprint, magazines, etc. The present invention includes all media formats and data reporting forms wherein bias corrected, prices-realized data including fair market values for encapsulated U.S. coins can be disseminated to marketplace participants.

In the FIG. 15B there is also illustrated a data reporting module pertaining to “closed” U.S. coin auction historical archive listings 107. As indicated above, auction facilities such as eBay™ for example, do not provide perpetual access to a historical archive of completed auctions. With respect to the present invention, it preferred that such data be stored for future retrieval and verification purposes. Those skilled in the art will readily recognize and appreciate that appropriately configured hyperlinks to an archive of “closed” auction listings could be provided with relative ease. Therefore, it is preferred that each auction facility provide long term storage and support for a perpetual “closed” auction archive, however such on-line archival data may be provided by any duly authorized and capable entity.

It is well known in the art that certain die varieties, attributions and pedigrees impact prices-realized for encapsulated graded U.S. coins. No data reporting effort would be complete without identifying the marketplace variability with respect to fair market values for “special” designations. Therefore, in the FIG. 15B there is illustrated a data reporting module U.S. coin variety, attribute, pedigree and registry 108 pertaining to U.S. coin die marriages, die varieties, attributes, special minting procedures such as “proof” coins, ownership, provenance, pedigrees, etc.

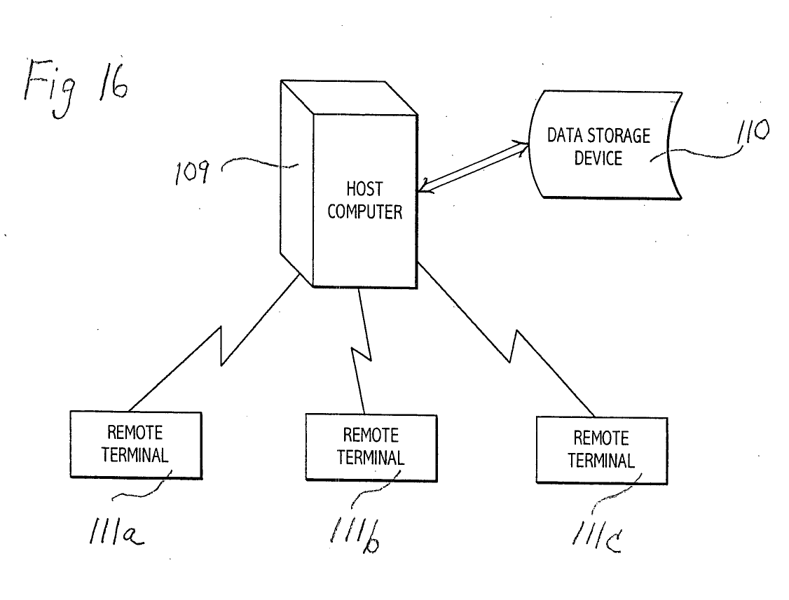

In an embodiment of the present invention, peer-to-peer trade data including fair market values are provided by a host computer system that is remotely accessible as shown in the FIG. 16. A host computer 109 is operatively connected to a storage device 110. The host computer 109 may be any type of computer as required for a particular level of operation of the invention such as a personal computer, a network server, a Web server, a microcomputer, a workstation, or a network of such computers. The storage device 110 may be any adequate storage device or multiples of devices such as hard disk drives, CD-ROMs, DVDs, etc.

When an interested party (user) wants to determine the trading history or fair market value for an encapsulated graded object, the user connects a remote terminal to the host computer 109 and accesses the trading history or fair market value information associated with the object of interest. Any number of remote terminals represented by 111a, 111b, and 111c can be connected to the host computer 109. The remote terminals 111a, 111b, and 111c may be any suitable device such as a dumb terminal, a notebook computer, a laptop computer, a personal computer, a wireless PDA, a cellular phone, etc. having sufficient processing and display capabilities in combination with the host computer 109 to access and review “relevant trade data” including fair market value information according to the present invention.

The remote terminals 111a, 111b, and 111c can be connected to the host computer 109 via any convenient means, such as through a direct connection, a direct wireless connection, a dial-up connection, a full-time network connection, an intranet connection, or an Internet connection, or any variation or equivalent thereof.

In one embodiment of the present invention the host computer 109 is maintained and controlled by an auction facility such as eBay™ for example. In an alternative embodiment the host computer 109 is maintained and controlled by a trusted third party grading firm. Alternatively, the host computer 109 is maintained and controlled by at least one independent third party acting as a liaison between the at least one grading firm and eBay™, for example. Whichever entity maintains and controls the host computer 109 it is to be understood that the present invention can be configured to leverage the inherent power of the World Wide Web's distributed content characteristic by providing an apparatus, method and system capable of presenting “relevant trade data” relating to encapsulated graded objects and that the such data may be linked to and displayed simultaneously. In a further aspect of the invention, if any remote terminal 111a, 111b, or 111c and the host computer 109 are connected via the Internet, the remote terminal can connect to two (or more) host computers each of which may be coupled to a data storage device containing relevant price histories and fair market value information. This would permit the user to compare fair market values or price histories from different sources. Presenting coalesced information simultaneously as if all the content of one Web document originated from a single source (host) is a powerful technical feature of the World Wide Web. Likewise, the linking capability inherent within Hypertext Markup Language (HTML) dramatically increases the utility of the World Wide Web by providing nonlinear links to various screen elements such as text, images, sound, streaming video, etc. It should therefore be readily evident to Web site authors and HTML programmers that the display of information on the World Wide Web relating to encapsulated graded objects can result from distributed content being simultaneously provided from more than one host computer. Thus, it is preferred that the present invention be configured for use on the World Wide Web, or an Intranet equivalent thereof.

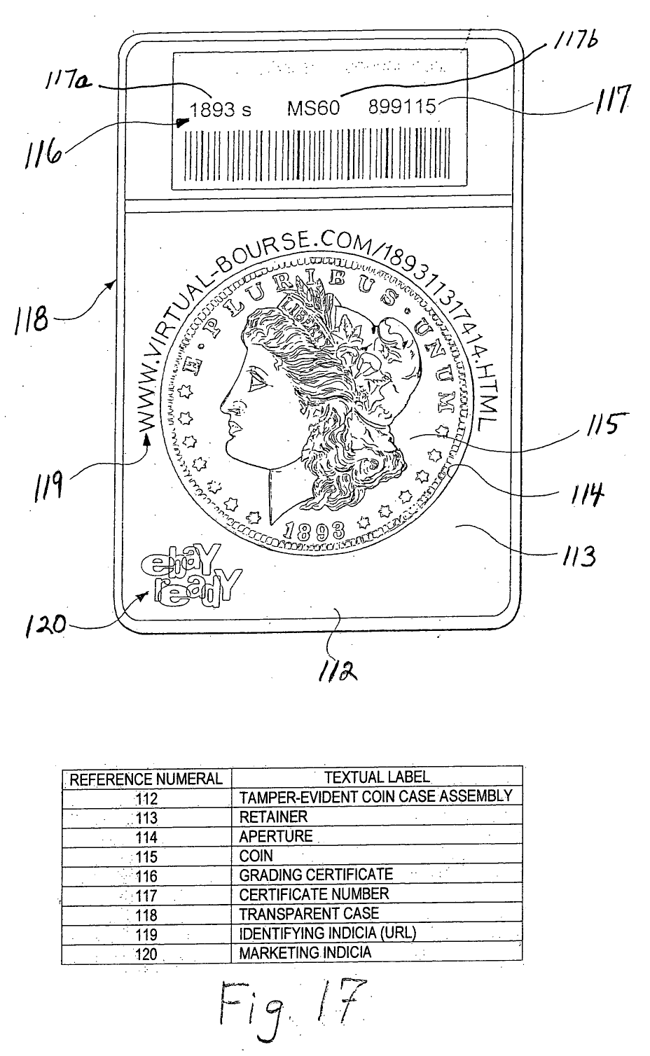

There is shown in the FIG. 17 a typical tamper-evident coin case assembly 112 utilized and promoted by third party grading firms. The assembly 112 includes a generally planar coin retainer 113 having an aperture 114 formed through it for retaining a coin 115 such that both sides of the coin are completely visible. A generally planar grading certificate 116 is prepared by the third party grading firm to provide information about the coin 115 such as a grade indicator 117b “MS60”, a year and mint indicator 117a “1893 S” and a unique certificate number 117 “899115”. The retainer 113, the coin 115 and the certificate 116 with the certificate number 117 and the indicators 117a and 117b are then encapsulated in a holder such as a transparent case 118. Once sealed by sonic welding or other appropriate means, the tamper-evident assembly can be traded from seller to buyer with a high degree of confidence in the authenticity and grade of the coin 115.

The certificate number 117 can either be replaced by or supplemented by a unique identifying indicia 119 that permits locating the associated peer-to-peer trade data, including calculated fair market values and possibly certified trusted images of the coin 115. If the encapsulated coin has been imaged according to the teachings of U.S. Pat. No. 6,366,899, the means for examination of trusted high-resolution images could also be provided. During the grading process, relevant trade data for the coin 115 is stored in an appropriately configured storage means 110 (FIG. 16) operatively connected to the host computer 109 (FIG. 16). The “relevant trade data” for the coin 115 can be accessed by using identifying indicia 119 in the form of a URL as shown. For example, when a user wishes to sell a coin within an online peer-to-peer marketplace such as eBay™ for example, the exemplary identifying indicia 119

http://www.virtual-bourse.com/189311317414.html

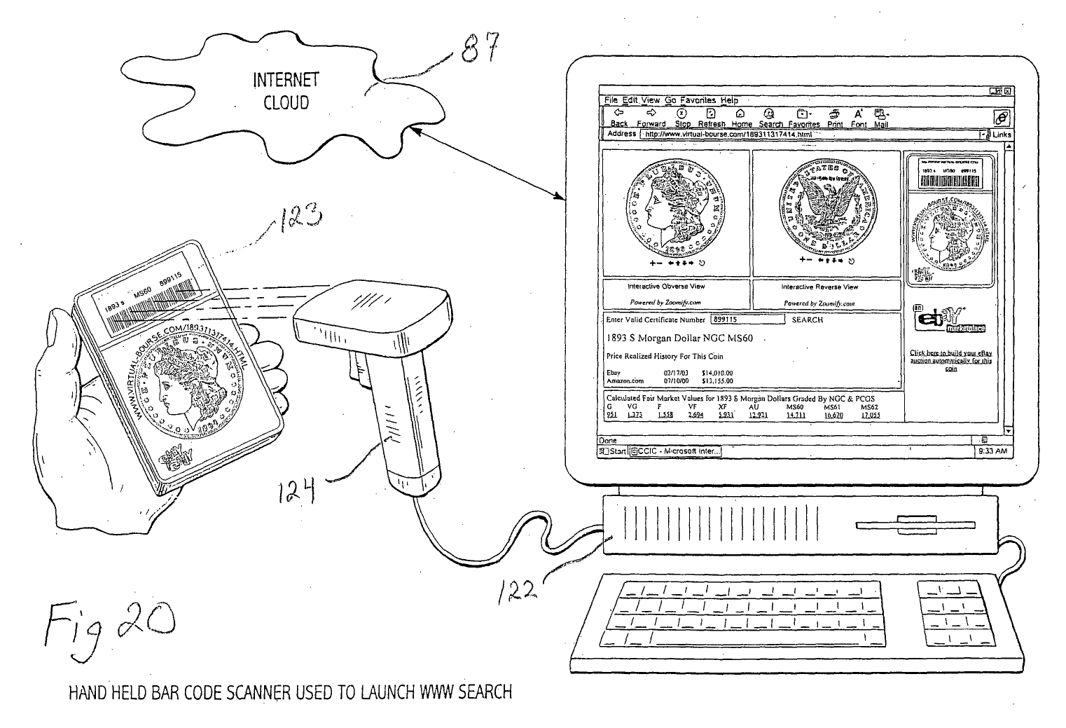

affixed to the “tamper-evident” coin case assembly 112 permits the seller to more easily communicate the trade relevant characteristics of the coin including its stored “relevant trade data” to the auction facility. The identifying indicia 119 can be applied to: the retainer 113, the grading certificate 116, the interior of the case 118 before encapsulation, or the exterior of the case 118 after encapsulation by any suitable method such as printing or engraving. The identifying indicia 119 can serve as a database locator and as an alternate certificate number 117 whether or not the coin 115 has a certificate number 117 associated with it. When the identifying indicia 119 is configured to serve as a URL it can be reproduced in bar code form 123 as shown in FIG. 20 for reading by automatic scanning equipment 124 as shown in FIG. 20. The exemplary marketing indicia 120 represented by “eBay ready” indicates that the illustrated encapsulated graded coin 115 is commoditized and therefore can be more readily traded online. An encapsulated graded coin being conspicuously marked or inscribed with an appropriately configured marketing indicia 120 signals to the public that the encapsulated coin 115 can be exchanged in the marketplace utilizing a peer-to-peer trading venue (e.g. eBay™) willing to receive predetermined at least relevant trade data assigned and associated with the unique encapsulated graded coin. Encapsulated graded objects possessing already assigned and associated data characteristics including stored at least “relevant trade data” thereby making such objects “marketplace-ready” shall constitute an embodiment of the present invention. One or more steps of a method for commoditizing a plurality of encapsulated graded objects may be undertaken prior to encapsulation or alternatively, after encapsulation. It is understood that third party grading firms are uniquely positioned within the marketplace, and possess the requisite level of credibility, making them preferred candidates to practice this aspect of the present invention, however commoditizing encapsulated graded objects according to the present teachings is in no way limited to third party grading firms.

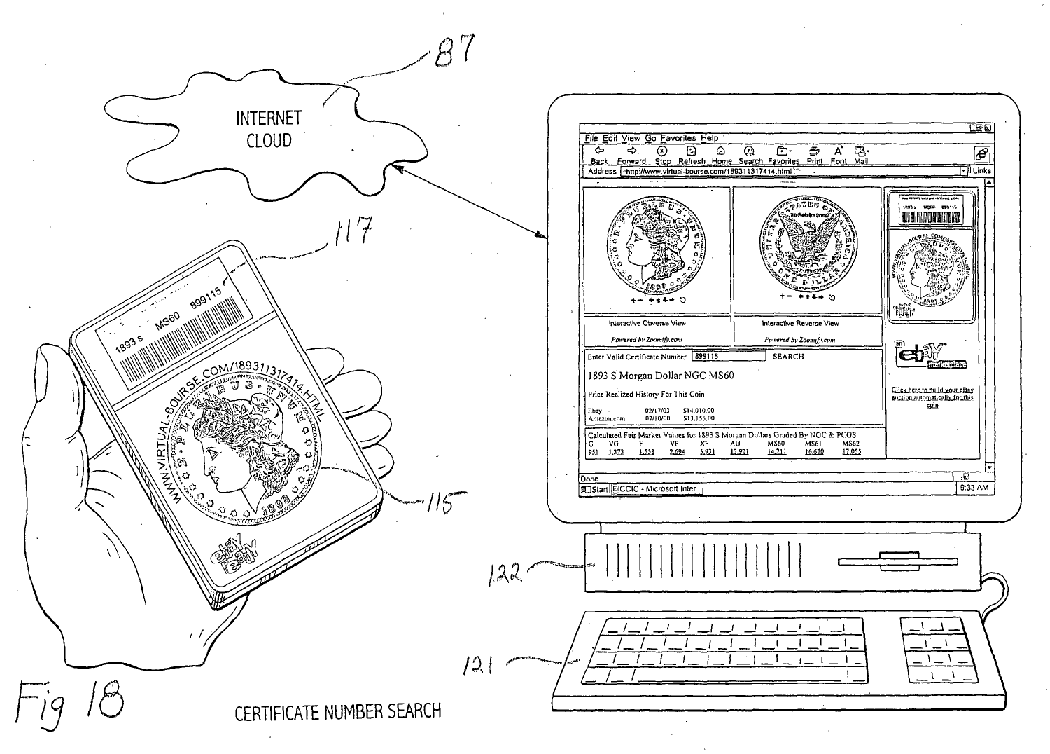

FIG. 18 shows a data entry method and an illustrative resultant display of a full-text search request wherein the user has keyed a certificate number 117 assigned and associated with a unique encapsulated graded coin 115 using a standard keyboard 121 operatively connected to a personal computer 122. The illustrated personal computer 122 is connected to the Internet 87 by any available means such as through a direct connection, a direct wireless connection, a dial-up connection, a full time network connection, an intranet connection, or an Internet connection, or any variation thereof.

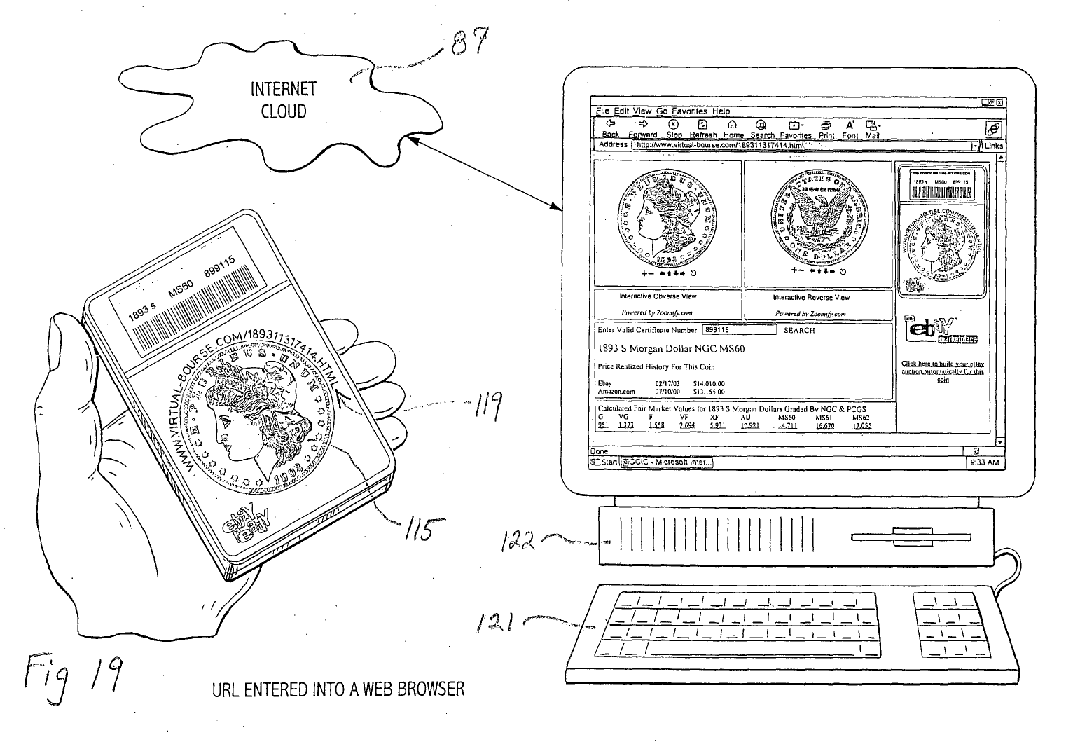

FIG. 19 shows a data entry method and an illustrative resultant display of a full-text search request wherein the user has keyed the text string specific to a standard HTTP URL 119 request using a standard keyboard 121 wherein the URL 119 is assigned and associated with a unique encapsulated graded coin 115. The illustrated personal computer 122 is connected to the Internet 87 by any available means such as through a direct connection, a direct wireless connection, a dial-up connection, a full time network connection, an intranet connection, or an Internet connection, or any variation thereof.

FIG. 20 shows a data entry method and an illustrative resultant display of a search request wherein the user has scanned a URL encoded barcode 123 with a standard barcode scanner 124 operatively connected to a personal computer 122. The illustrated exemplary URL encoded barcode 123 being specifically assigned and associated with a unique encapsulated graded coin. The illustrated personal computer 122 is connected to the Internet 87 by any available means such as through a direct connection, a direct wireless connection, a dial-up connection, a full time network connection, an intranet connection, or an Internet connection, or any variation thereof.

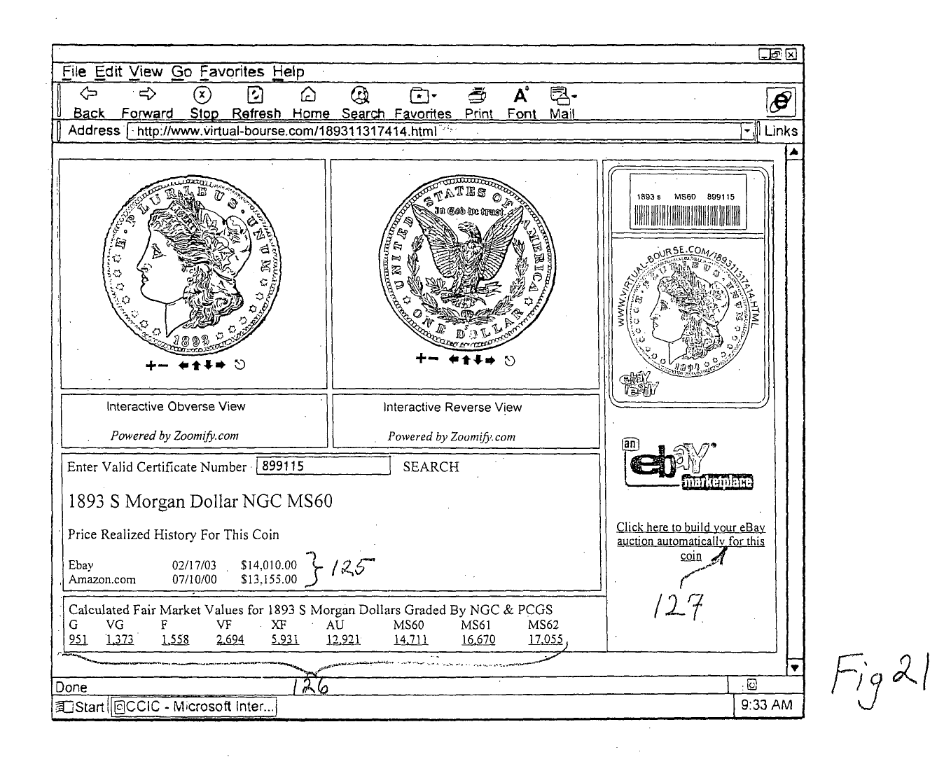

The FIG. 21 relates to each of the foregoing drawings FIG. 18, FIG. 19 and the FIG. by depicting an enlarged exemplary HTML page showing historical price-realized trade data 125 relating specifically to the exemplary encapsulated coin being presented and grade specific fair market values 126 for like “type” coins which at a minimum, share the same date, denomination and mintmark as the exemplary encapsulated coin illustrated. In addition, the FIG. 21 shows a hyperlink 127 for initiating a fixed price trade offer or alternatively, an auction-style listing in a streamlined manner wherein an appropriately configured host computer 109 (not shown in the FIG. 21) is able to communicate “relevant trade data” to an online peer-to-peer trading venue via any appropriately configured means (e.g. eBay's XML API programming environment).

While not specifically illustrated, it will be understood and appreciated by those skilled in the art that a robust market actively trading in commoditized encapsulated graded objects could be developed through the cooperation of at least one third party grading firm, at least one firm operating an online peer-to-peer trading facility, and at least one third party market enabling firm (liaison). The grading firm(s) would grade each object, image each object, and store for later retrieval the minimum “relevant trade data” associated with each object. A storage device operatively connected to a host computer would store the minimum relevant trade data captured by the grading firm. A trusted third party acting as a liaison between the grading firm(s) and the online peer-to-peer trading venue(s) would facilitate the initiation of any fixed price trade offer or auction-style listing to be undertaken. Such facilitation may be made possible via the World Wide Web component of the Internet using interconnected computers. In addition the aforementioned third party liaison would also be responsible for storing additional relevant trade data such as prices-realized gathered (or fair market values compiled) from the at least one participating online peer-to-peer trading facility.

It will be understood and appreciated by those skilled in the art that a robust market actively trading in commoditized encapsulated graded objects could be developed in an alternative manner, wherein for example, at least one firm operating an online peer-to-peer trading facility and at least one third party market maker (liaison) could work cooperatively without requiring the direct involvement of any third party grading firm. The market maker (liaison) could provide initial public offerings (IPO's) of commoditized encapsulated graded objects by acting as a “first” seller within the peer-to- peer trading venue. Additionally, the market maker could select raw or encapsulated objects to be offered for sale or exchange. The market maker could also be responsible for capturing and storing all relevant trade data including images of each object prior to encapsulation or after encapsulation. In the case of raw objects, the objects to be later traded (via an IPO) would be first submitted to a trusted third party grading firm for authentication, grading and encapsulation. The market maker could undertake the assignment of a unique identifying indicia 119 for effectuating the retrieval of relevant trade data and the application of a market insignia 120 (marketing indicia) for each encapsulated graded object. The market maker could apply (affix) the unique identifying indicia and the marketing indicia to the outer surface of the graded object's protective plastic assembly (plastic case) using any suitable means such as laser inscription, engraving, etching, printing or any equivalent means. In this way the direct cooperation of any third party grading firm for commoditizing the encapsulated graded objects would not be necessary. Following any IPO, the trusted third party market maker acting in liaison with the online peer-to-peer trading venue would facilitate the initiation of any “subsequent” fixed price trade offer or auction-style listing to be undertaken by sellers within the commoditized market. The facilitation of any number of “subsequent” trades could be made possible by providing a hyperlink 127 as illustrated in the FIG. 21. In addition the aforementioned third party liaison would also be responsible for disseminating additional “new” relevant trade data as it may become available such as prices realized gathered (or fair market values compiled) from the at least one participating online peer-to-peer trading facility.

Of course, the at least one online peer-to-peer trading venue could streamline much of the aforementioned activities through its own initiative, thereby compiling historical prices-realized and fair market values for commoditized objects as they actively trade.

Accordingly, any suitable configuration of market maker activities or combination of entities participating within a market wherein a firm operating as an online peer-to-peer trading venue enables trade in commoditized encapsulated graded objects pursuant to the herein disclosed teachings, shall constitute an embodiment of the present invention.

While the present invention has been discussed in the context of numismatic material, it will be understood by those skilled in the art that it may be used to create a market for any commoditized object that buyers would like to purchase such as collectible stamps, sports trading cards, currency, documents (such as letters and stock certificates), etc.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method for grading, encapsulating and commoditizing objects thereby making the objects trade ready, the method comprising the steps of:
a) grading an object based upon a predetermined grading scale and generating a grade indicator for the object;
b) associating the grade indicator with the object in a substantially permanent manner by encapsulating the object and a visual representation of the grade indicator in a tamper-evident holder; and
c) commoditizing the object by generating relevant textual trade data for the object and storing the relevant textual trade data in a database in a form for use in generating a trade listing for the object.

2. The method according to claim 1 including performing said steps a) through c) for a plurality of objects and providing access to the relevant textual trade data in the database to sellers to generate trade listings for the objects.

3. The method according to claim 2 including providing access to the trade listings to the sellers and to buyers within an online peer-to-peer trading environment.

4. The method according to claim 2 including assigning a unique identifying indicia to each of the objects and associating the assigned unique identifying indicia with the corresponding one of the objects encapsulated in the holder in a substantially permanent manner.

5. The method according to claim 4 wherein for each of the objects said step c) further includes printing the assigned associated unique identifying indicia onto a label and securing the printed label within the tamper-evident holder thereby providing a substantially permanent identifying indicia for the object.

6. The method according to claim 4 including a step of connecting the database to a host computer, connecting a remote terminal to the host computer, sending a selected one of the unique identifying indicia from the remote terminal to the host computer and retrieving from the database at the remote terminal the relevant textual trade data for the one of the objects associated with the selected one of the unique identifying indicia.

7. The method according to claim 4 including a step of generating at least one image of each of the objects, digitizing the images for viewing, storing the digitized images in the database and assigning to each of the images stored in the database a corresponding one of the associated unique identifying indicia.

8. The method according to claim 7 including a step of connecting the database to a host computer, connecting a remote terminal to the host computer, sending a selected one of the unique identifying indicia from the remote terminal to the host computer and retrieving from the database at the remote terminal each stored image for the one of the objects associated with the selected one of the unique identifying indicia.

9. The method according to claim 4 wherein each of the unique identifying indicia is an assigned unique certificate number, the unique certificate numbers having a predetermined format for retrieving the stored relevant textual trade data associated with the objects.

10. The method according to claim 4 wherein the unique identifying indicia is an assigned unique URL, the unique URL's having a predetermined format for retrieving the stored relevant textual trade data associated with the objects.

11. The method according to claim 4 wherein the unique identifying indicia is an assigned unique machine readable bar code, the unique bar codes having a predetermined format for retrieving the stored relevant textual trade data associated with the objects.

12. The method according to claim 2 including a step of providing a marketing indicia for each of the objects, the marketing indicia being physically associated with the tamper-evident holders encapsulating the objects, the marketing indicia being visibly conspicuous thereby indicating that the objects are trade ready within an online peer-to-peer trading environment.

13. The method according to claim 2 wherein the objects are at least one of coins, stamps, trading cards, currency and documents.

14. The method according to claim 2 including generating trade listings from the stored relevant textual trade data in at least one trade enabling marketplace computer and providing access to the trade listings to the sellers and to buyers of the objects through computers connected to the marketplace computer.

15. The method according to claim 2 wherein the objects are coins and the stored relevant textual trade data is at least one of a plurality of item specific attributes associated with the coins, the item specific attributes including a certificate number, a year of mintage indicator, a Mint branch indicator, a denomination indicator, a coin type designation, a coin grade indicator, and a coin grading firm identifier.

16. The method according to claim 2 wherein the objects are coins and including assigning a unique identifying indicia to each of the coins, associating the assigned unique identifying indicia with the corresponding one of the coins encapsulated in the holder in a substantially permanent manner, and retrieving the stored relevant textual trade data from the database utilizing the assigned unique identifying indicia associated with each of the coins.

17. A method for facilitating the exchange of trade ready graded encapsulated objects utilizing a network of interconnected computers, the method comprising the steps of:
a) providing a marketplace computer and receiving at the marketplace computer data over a network from a relevant trade data host computer, the received data pertaining to graded encapsulated objects offered for sale and including relevant trade data associated with each of the objects, each of the objects having a substantially permanent uniquely assigned identifying indicia for effectuating the transmission of the relevant trade data associated with the objects;
b) responding to the data received from the host computer by storing the included relevant trade data in the marketplace computer;
c) generating in the marketplace computer a unique presentation format relating to the objects offered for sale; and
d) providing access to the marketplace computer to a plurality of buyer computers across the network for displaying at the buyer computers the unique presentation format including the relevant trade data of a selected one of the objects.

18. The method according to claim 17 including performing said step d) in response to a request from a one of the buyer computers wherein the marketplace computer transmits data including the unique presentation format across the network to the requesting one of the buyer computers.

19. The method according to claim 18 wherein the transmitted data includes at least a minimum of relevant textual trade data necessary for generating the unique presentation format relating to the selected object, the generated unique presentation format being an online peer-to-peer trade listing.

20. The method according to claim 19 wherein the objects offered for sale are trade ready graded encapsulated commoditized coins and the minimum relevant textual trade data includes a plurality of item specific attributes associated with the coins, the item specific attributes comprising a certificate number, a year of mintage indicator, a Mint branch indicator, a denomination indicator, a coin type designation, a coin grade indicator, and a coin grading firm identifier.

21. The method according to claim 17 including performing said step d) wherein the marketplace computer responds to a search request from one of the buyer computers by searching the stored data, the search request including at least one of a plurality of item specific attributes associated with the coins and included in the relevant trade data, the plurality of item specific attributes comprising a certificate number, a year of mintage indicator, a Mint branch indicator, a denomination indicator, a coin type designation, a coin grade indicator, and a coin grading firm identifier; and wherein the marketplace computer transmits a result of the search request to the one buyer computer.

22. The method according to claim 17 wherein said step a) is performed by providing the marketplace computer at an online peer-to-peer trading facility and transmitting the data from the host computer to the online peer-to-peer trading facility marketplace computer via XML data exchange.

23. The method according to claim 17 wherein said step a) includes providing the host computer at a third party grading firm acting as a marketplace intermediary and operating the host computer to provide the relevant trade data to the marketplace computer on behalf of a plurality of seller computers, the seller computers having network access to the marketplace computer.

24. The method according to claim 17 wherein said step a) includes operating the host computer as a proxy seller computer with network access to a plurality of seller computers, the seller computers creating online peer-to-peer trade listings at the marketplace in a predetermined manner.

25. A method of facilitating the exchange of graded encapsulated coins over a network among a plurality of interconnected computers, the method comprising the steps of:
a) receiving at a marketplace computer data over a network from seller computers, the data pertaining to graded encapsulated coins offered for sale, the coins each being secured within a tamper-evident holder and having a substantially permanent uniquely assigned identifying indicia physically associated therewith, the data including relevant trade data uniquely associated with each of the coins offered for sale and including at least one of a date indicating a year of mintage, a mintmark indicator, a coin type designation, a denomination, a grade indicator and a grading firm identity;
b) storing the data received from the seller computers in a data storage means;
c) generating a presentation format in the marketplace computer; and
d) providing access to the marketplace computer over the network to a plurality of buyer computers, obtaining the stored data from the data storage means and presenting the relevant trade data to the buyer computers in the presentation format.

26. The method according to claim 25 including a step of receiving a search request from one of the buyer computers, performing a search in the data storage means in response to the search request and generating a result of the search from the marketplace computer to the one buyer computer.

27. The method according to claim 26 wherein the search request includes at least one trade relevant item specific attribute from the attributes comprising a date indicating a year of mintage, a mintmark indicator, a coin type designation, a denomination, a grade indicator and a grading firm identity.

28. The method according to claim 26 wherein the search request includes a selected one of the uniquely assigned identifying indicia.

29. The method according to claim 25 wherein each of the unique identifying indicia is a certificate number unique to the associated one of the coins.

30. The method according to claim 25 wherein said step c) includes the presentation of at least one image of at least one of the coins offered for sale.

31. The method according to claim 25 wherein said step c) includes the presentation of a grade specific fair market value associated with at least one of the coins offered for sale.

32. The method according to claim 25 wherein said step c) includes the presentation of historical price realized data associated with at least one of the coins offered for sale.

33. A method for providing a database of price realized information associated with the exchange of graded encapsulated objects, the method comprising the steps of:
a) selecting a graded encapsulated object based upon a predetermined selection criteria, the graded object being encapsulated in a tamper-evident holder with an associated grade indicator and having an assigned unique identifying indicia, said assigned unique identifying indicia being associated with the graded object in a substantially permanent manner;
b) storing data including price realized information in a database for the selected graded encapsulated object and associating the stored data in the database with the unique identifying indicia assigned to the selected graded encapsulated object;
c) repeating said steps a) and b) for a plurality of graded encapsulated objects; and
d) providing access to the stored data in the database by selecting one of the assigned associated unique identifying indicia.

34. The method according to claim 33 wherein the unique identifying indicia is an assigned certificate number, the certificate number having a predetermined format for retrieving the data from the database.

35. The method according to claim 33 wherein the unique identifying indicia is an assigned unique URL, the URL having a predetermined format for retrieving the data from the database.

36. The method according to claim 33 wherein the unique identifying indicia is an assigned machine readable bar code, the bar code having a predetermined format for retrieving the data from the database.

37. The method according to claim 33 including a step of connecting the database to a host computer, connecting a remote terminal to the host computer, sending a selected one of the unique identifying indicia from the remote terminal to the host computer, generating from the host computer to the remote terminal the stored data corresponding to the selected unique identifying indicia and reviewing the price realized information at the remote terminal.

38. The method according to claim 33 wherein the objects are one or more of coins, stamps, trading cards, and documents.

39. The method according to claim 33 wherein said step b) is performed by storing price realized information gathered from a plurality of completed online peer-to-peer transactions involving selected ones of the objects.

40. The method according to claim 39 wherein the completed online peer-to-peer transactions are completed online peer-to-peer auction transactions and said step b) is performed by storing price realized information gathered from a plurality of completed online auction transactions involving selected graded encapsulated objects, said step b) further including storing at least one of an auction listing identifier, closing date of the auction listing, an associated grade indicator and a grading firm identifier.

41. The method according to claim 39 wherein said completed online peer-to-peer transactions are completed online peer-to-peer fixed price transactions and said step b) is performed by storing price realized information gathered from a plurality of completed online fixed price transactions involving selected graded encapsulated objects, said step b) further including storing at least one of a fixed price trade listing identifier, closing date of the fixed price trade listing, associated grade indicator and grading firm identifier.

42. A method for providing a database of information associated with encapsulated graded objects, the method comprising the steps of:
a) gathering selected data from a pool of data representing completed online peer-to-peer transactions related to the sale of graded encapsulated objects;
b) storing the gathered selected data in a database, said gathered selected data including price realized information and at least one of an encapsulation indicator, an assigned grade indicator and a grading firm indicator;
c) correcting a bias in said gathered selected data wherein said bias was induced by amalgamating online peer-to-peer transaction data into a data pool without regard for encapsulation, grade and grading firm; and
d) repeating said steps a) through c) for a plurality of online peer-to-peer transactions relating to the sale of graded encapsulated objects and storing the bias corrected gathered selected data in a database and connecting the database to a host computer.

43. The method according to claim 42 wherein said step a) includes searching a plurality of online peer-to-peer trading facilities for relevant trade data associated with encapsulated graded objects.

44. The method according to claim 43 wherein said step a) is performed by searching manually.

45. The method according to claim 43 wherein said step a) is performed using a persistent operative scanning agent.

46. The method according to claim 43 wherein said step a) is performed by obtaining an online peer-to-peer transaction data pool from a peer-to-peer transaction data provider.

47. The method according to claim 42 wherein the online peer-to-peer transactions relating to graded encapsulated objects involve graded encapsulated objects each having substantially permanent assigned unique identifying indicia and said step a) is effectuated by using the assigned unique identifying indicia corresponding to encapsulated graded objects.

48. The method according to claim 42 wherein said step c) includes an application of a statistical model to price realized data associated with the sale of relevant graded encapsulated objects, the statistical model being used to calculate a mean price realized.

49. The method according to claim 48 wherein the application of a statistical model to the gathered selected data includes calculating a ninety-five percent confidence interval associated with a normal distribution of price realized data and wherein the price realized data lying outside of two standard deviations is considered statistically insignificant.

50. The method according to claim 48 wherein the application of a statistical model to the gathered selected data includes calculating a ninety-five percent confidence interval associated with a normal distribution of price realized data and wherein price realized data lying within the calculated ninety-five percent confidence interval is considered to be statistically significant.

51. The method according to claim 42 wherein the graded encapsulated objects are one or more of coins, stamps, trading cards, currency and documents.

52. An integrated market exchange system facilitating trade in graded encapsulated commoditized coins, the system comprising:
a marketplace computer operatively controlled by an online peer-to-peer trade enabling facility, said marketplace computer storing data associated with offers to sell and offers to buy graded encapsulated commoditized coins, the graded encapsulated commoditized coins being selected from a plurality of graded encapsulated coins provided by at least one third party grading firm;
a host computer operatively controlled by a market maker engaged in the trade of graded encapsulated commoditized coins, said host computer storing relevant trade data associated with the graded encapsulated commoditized coins; and
a communication means connecting said marketplace computer with said host computer and connecting coin sellers and coin buyers with said marketplace computer whereby the coin sellers and the coin buyers are provided access to said relevant trade data stored in said host computer.

53. The system according to claim 52 wherein the graded encapsulated commoditized coins are tamper-evident trade ready graded encapsulated commoditized coins each having an assigned and substantially permanent unique identifying indicia.

54. The system according to claim 52 wherein the graded encapsulated commoditized coins are tamper-evident trade ready graded encapsulated commoditized coins and including a data storage means operatively connected to said host computer storing said relevant trade data.

55. The system according to claim 52 wherein said marketplace computer provides access to said host computer to a marketplace computer transaction environment in a predetermined streamlined manner, said predetermined streamlined manner being effectuated by said host computer communicating said relevant trade data to said marketplace computer in a form compatible with the marketplace computer transaction environment.

56. The system according to claim 55 wherein said form compatible with the marketplace computer transaction environment includes permitting said host computer to effectuate actions within the marketplace transaction environment including initiation of an auction style trade listing and initiation of a fixed price trade listing.

57. The system according to claim 55 wherein the form compatible with the marketplace computer transaction environment includes XML data exchange.

58. The system according to claim 52 wherein said marketplace computer responds to an offer to buy from one of the coin buyers that matches on offer to sell from one of the coin sellers by generating transaction data enabling the one coin buyer to acquire an associated one of the trade ready graded encapsulated commoditized coins from the one coin seller.
